(19) United States
(12) Patent Application Publication
(10) Pub. No.: US 2026/0175384 A1
(43) Pub. Date: Jun. 25, 2026

(54) DRIVING TOOL

(71) Applicant: MAKITA CORPORATION, Anjo-shi (JP)

(72) Inventors: Makito TERAMOTO, Anjo-shi (JP); Kiyonobu YOSHIKANE, Anjo-shi (JP); Tatsuya IKEDO, Anjo-shi (JP)

(73) Assignee: MAKITA CORPORATION, Anjo-shi (JP)

(21) Appl. No.: 19/413,011

(22) Filed: Dec. 9, 2025

(30) Foreign Application Priority Data
Dec. 24, 2024 (JP) 2024-227231
Dec. 24, 2024 (JP) 2024-227254
Jul. 22, 2025 (JP) 2025-122187

(51) Int. Cl. B25C 1/04

(52) U.S. Cl. CPC B25C 1/047; B25C 1/041

(57) ABSTRACT

The driving tool has a driving mechanism and a lifter. The driving mechanism biases a driver forward, and the lifter moves the driver rearward. The driving tool has an upstream rotating member (driven spur gear), a downstream rotating member (driving ring), and a buffering member. The upstream rotating member is positioned in the power transmission path that transmits power from an electric motor to the lifter and rotates about its axis. The downstream rotating member rotates coaxially with the upstream rotating member on a downstream side of the upstream rotating member. The buffering member is interposed between the upstream rotating member and the downstream rotating member. The rotational power of the upstream rotating member is transmitted to the downstream rotating member while being buffered through the buffering member.

### CROSS-REFERENCE TO RELATED APPLICATION

This application claims priority to Japanese patent application serial number 2024-227231, filed on Dec. 24, 2024, to Japanese patent application serial number 2024-227254, filed on Dec. 24, 2024, and to Japanese patent application serial number 2025-122187, filed on Jul. 22, 2025, the contents of which are incorporated herein by reference in their entirety for all purposes.

### TECHNICAL FIELD

The present invention generally relates to a driving tool for driving a driving member into a workpiece.

### BACKGROUND

For example, a so-called gas spring type driving tool is well-known. The gas spring type driving tool has a driver, a driving mechanism, an electric motor, and a lifter. The driver moves in a driving direction by the driving mechanism and moves in a direction opposite to the driving direction by the lifter. The driving mechanism has a cylinder that extends in the driving direction and a piston that is movable within the cylinder and formed integrally with the driver. The lifter is driven by the output of the electric motor transmitted through a reduction gear, a planetary reduction mechanism, or other transmission components. When the lifter is driven to move the driver and the piston in the direction opposite to the driving direction, the gas pressure in the accumulation chamber, which is above the piston, increases. The driver moves in the driving direction using this gas pressure as a driving force. A driving member (e.g., nails) is sequentially supplied from a magazine to a driving passage in front of the driver in the driving direction. The driving member is driven into the workpiece by the driver that moves in the driving direction.

In a power transmission path from the electric motor to the lifter, an impact may be transmitted due to various causes. For example, when the lifter moves the driver at its bottom dead center in a direction opposite to the driving direction, the lifter receives a reaction force from the driver. The impact due to the reaction force may be transmitted through the lifter to the power transmission path. In addition, in the unlikely event of a nail jam in the driving passage, the driver and the lifter may not engage in the proper position, resulting in a misalignment of the driver and the lifter. Engaging portions (engaging pins) of the lifter are normally retracted from the path of the driver moving in the driving direction to avoid contact with the driver. However, in abnormal conditions where the driver and the lifter are not engaged normally, some of the engaging portions of the lifter may not be able to fully retract from the path of the driver moving in the driving direction. This causes a large impact from the driver to the lifter via the engaging portion. Furthermore, this impact may also be transmitted to the power transmission path via the lifter. The impact may damage the gears and other components along the power transmission path.

For example, a gas spring type driving tool is well known, which is equipped with a planetary reduction mechanism in the power transmission path and a buffering mechanism to suppress the transmission of an impact from the lifter to the planetary reduction mechanism (especially the final speed reduction gear train). The buffering mechanism is arranged between the gear housing that houses the planetary speed reduction gear train and the internal gear of the final gear train. To date, no conventional driving tools have been provided with bevel gears, spur gears, helical gears, etc. in the power transmission path, while also incorporating a buffering mechanism. For example, driving tools are also well known, which is equipped with bevel gears and spur gears in the power transmission path, but they do not disclose a structure that suppresses the transmission of the impact from the lifter to the power transmission path.

Unlike the planetary gear reduction mechanism, it is difficult to interpose the buffering mechanism between the gear housing, which houses each gear in the power transmission path, and any of the gears. Therefore, the buffering mechanism in the prior art cannot be directly applied to a driving tool that includes bevel gears, spur gears, helical gears, etc. in its power transmission path.

Furthermore, in the driving tool, the motor and the gear, etc. in the power transmission path and the lifter are allowed to rotate in the forward rotation direction and are restricted from rotating in the reverse rotation direction. If the motor, the gears, and the lifter are freely reversible, it would not be possible to hold the driver in the standby position. Therefore, conventional driving tools are provided with a stopper that restricts the rotational direction of the electric motor, the gears, and the lifter in the forward rotation direction only.

For example, a driving tool in the prior art discloses a stopper provided relatively upstream in the power transmission path of the planetary reduction mechanism, specifically between the first and second planetary gear stages of a three-stage reduction mechanism. The stopper functions to restrict reverse rotation by permitting a slight rotational movement upon receiving a force in the reverse direction, and subsequently halting the rotation. By increasing a number of reduction stages downstream of the stopper, the reduction ratio between the stopper and the lifter can be increased. As a result, the angle of a reverse rotation of the lifter until it stops is smaller than that of the stopper. Therefore, the amount of driver displacement during reverse rotation can be minimized. The lifter receives a large force in the reverse rotation direction when the driver is in the standby position. Therefore, the positional error of the driver, especially at the standby position, can be minimized.

Furthermore, a driving tool is well known, which is equipped with a bevel gear and a spur gear in the power transmission path. To date, no conventional driving tools have been provided with bevel gears, spur gears, helical gears, etc. in the power transmission path instead of planetary reduction mechanisms, while also incorporating a stopper that restricts the direction of rotation in one direction.

### SUMMARY

Therefore, there is a need for a driving tool that can incorporate bevel gears, spur gears, helical gears, etc. to the power transmission path between the electric motor and the lifter, while also suppressing the transmission of an impact from the lifter to the motor and power transmission path.

Furthermore, there is a need for a driving tool that can incorporate bevel gears to the power transmission path between the electric motor and the lifter, while also restricting the reverse rotation of the lifter.

According to one feature of the present disclosure, a driving tool has a driving mechanism and a lifter. The driving mechanism biases the driver forward. The lifter moves the driver backward. The driving tool has an upstream rotating member, a downstream rotating member, and a buffering member. The upstream rotating member is located in the power transmission path that transmits power from the electric motor to the lifter and rotates around its shaft. The downstream rotating member rotates coaxially with the upstream rotating member downstream of the upstream rotating member. A buffering member is interposed between the upstream rotating member and the downstream rotating member. The rotational power of the upstream rotating member is transmitted to the downstream rotating member while being buffered through the buffering member.

Therefore, when the upstream rotating member rotates forward, the buffering member transmits the rotational power of the upstream rotating member to the downstream rotating member while buffering the rotational power of the upstream rotating member. Therefore, the rotational power of the upstream rotating member can be reliably transmitted to the downstream member. When an impact is transmitted from the lifter to the downstream rotating member, the impact is buffered by the buffering member before being transmitted to the upstream rotating member. In addition, the buffering member is always interposed in the path where the impact is transmitted from the downstream rotating member to the upstream rotating member. This configuration effectively suppresses the transmission of the impact from being transmitted from the downstream lifter to the electric motor and the power transmission path located upstream.

Moreover, the upstream rotating member and the downstream rotating member can be applied to various components that mutually rotate around the same axis. For example, the downstream rotating member can be made integral with the lifter shaft or with a rotating component upstream from the lifter shaft. For example, the upstream component can be a gear in a reduction gear, such as a bevel gear, spur gear, or helical gear, or a component that can rotate together with these gears. Accordingly, bevel gears, spur gears, helical gears, etc. with the above configuration can be incorporated in the power transmission path between the electric motor and the lifter.

### BRIEF DESCRIPTION OF DRAWING

FIG. 1 is a perspective view of a driving tool according to a first embodiment of the present disclosure, which is viewed from the upper left front.

FIG. 2 is a left side view of the driving tool.

FIG. 3 is a left side view of the driving tool, showing a pusher is lowered and held in place.

FIG. 4 is a front view of the driving tool.

FIG. 5 is a cross-sectional view taken along line V-V of FIG. 2.

FIG. 6 is a cross-sectional view taken along line VI-VI of FIG. 2.

FIG. 7 is a cross-sectional view taken along line VII-VII of FIG. 6, showing a driver has moved to a bottom dead center.

FIG. 8 is a similar view as FIG. 7, showing the driver is at a standby position.

FIG. 9 is a perspective view of the driving tool, which is viewed from the lower left front.

FIG. 10 is a cross-sectional view taken along line X-X of FIG. 2.

FIG. 11 is a right side view of the driving tool.

FIG. 12 is a right side view of the driving tool without a right housing

FIG. 13 is an exploded perspective view illustrating a mechanism unit, a motor housing, and a main body housing in a disassembled state.

FIG. 14 is a perspective view of a speed reduction mechanism.

FIG. 15 is an exploded perspective view of a stopper.

FIG. 16 is a cross-sectional view taken along line XVI-XVI of FIG. 5, showing a state where an inner ring rotates in a forward direction.

FIG. 17 is a similar view as FIG. 16, showing a state where the inner ring rotates in a reverse direction.

FIG. 18 is an exploded perspective view of a buffering mechanism, which is viewed from the upper left front.

FIG. 19 is an exploded perspective view of the buffering mechanism, which is viewed from the upper right front.

FIG. 20 is a cross-sectional view taken along line XX-XX of FIG. 6.

FIG. 21 is a driving tool according to a second embodiment of the present disclosure, showing a mechanism unit, a driving nose, and a magazine viewed from the right.

FIG. 22 is a cross-sectional view taken along line XXII-XXII of FIG. 21.

FIG. 23 is a cross-sectional view taken along line XXIII-XXIII of FIG. 22.

FIG. 24 is an exploded perspective view of a power transmission mechanism.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

The buffering member according to other features of the present disclosure has a first side surface and a second side surface. The first side surface is perpendicular to and elastically contacts the upstream side surface of the upstream rotating member in the rotational direction. The second side surface is perpendicular to and elastically contacts the downstream side surface of the downstream rotating member in the forward rotation direction relative to the first side surface 53a.

Therefore, during forward rotation of the upstream rotating member, the upstream side surface of the upstream rotating member pushes the first side surface of the buffering member in the forward rotation direction. During forward rotation of the upstream rotating member, the second side surface of the buffering member pushes the downstream side surface of the downstream rotating member in the forward rotation direction. Accordingly, it is possible to suppress the conversion of the rotational power of the upstream rotating member into a force that pushes the buffering member and the downstream rotating member in the axial direction. As a result, the rotational power of the upstream rotating member can be efficiently transmitted to the downstream rotating member. When an impact is transmitted from the lifter to the downstream rotating member, the upstream side surface of the downstream rotating member pushes the second side surface of the buffering member in the reverse rotation direction, and the first side surface of the buffering member pushes the upstream side surface of the upstream rotating member in the reverse rotation direction. Therefore, the buffering member and the upstream rotation shaft are restrained from being pushed in the axial direction. As a result, the impact transmitted from the downstream rotating member side to the upstream rotating member can be suppressed by the buffering member. It is also possible to suppress the transmission of the impact to the upstream rotating member in the axial direction.

According to other features of the present disclosure, the upstream rotating member has an upstream inclined side surface that is inclined with respect to the direction of rotation. The downstream rotating member has a downstream inclined side surface that faces the upstream inclined side surface and is inclined in the direction of rotation.

Therefore, it is possible to prevent the buffering member from being housed between the upstream inclined side surface and the downstream inclined side surface during assembly. Even if an attempt is made to house the buffering member between the upstream inclined side surface and the downstream inclined side surface, a space between the upstream inclined side surface and the downstream inclined side surface does not match the shape of the buffering member. Therefore, the buffering member cannot be housed between the upstream inclined side surface and the downstream inclined side surface for normal assembly. This makes it easy to check during an assembly work whether or not the buffering member is housed at the normal position between the upstream side surface and downstream side surface. Also, during the assembly work, the upstream and downstream rotating members are rotated relative to each other such that the upstream inclined side surface and the downstream inclined side surface are positioned closer to each other in the circumferential direction. This allows the buffering member to be assembled in such a way that it reliably comes into contact with both the upstream side surface and the downstream side surface.

According to other features of the present disclosure, the downstream rotating member rotates integrally with the lifter shaft of the lifter. The upstream rotating member rotates integrally with the final driven gear at the most downstream position in the power transmission path. Therefore, the buffering member is located downstream from the final driven gear, which is at the most downstream position in the power transmission path. This prevents the impact of the lifter from being transmitted to all the gears in the power transmission path.

According to other features of the present disclosure, a ball is interposed between the inner circumferential surface of the downstream rotating member and the outer circumferential surface of the lifter shaft. The downstream rotating member and the lifter shaft are coupled together via the ball, and are prevented from rotating relative to each other. Therefore, a simple connecting structure using the ball enables regulation of the relative rotation between the downstream rotating member and the lifter shaft, while facilitating assembly.

According to other features of the present disclosure, the upstream rotating member has external teeth and recesses. The external teeth are formed on the outer circumferential surface of the upstream rotating member. The recess is formed on a surface facing the downstream rotating member. At least a part of the buffering member is housed in the recess. Therefore, by housing the buffering member in the recess of the upstream rotating member, the buffering mechanism assembling the upstream rotating member, the buffering member, and the downstream rotating member can be compactly installed.

According to other features of the present disclosure, the buffering member is housed within the axial width of the upstream rotating member. Therefore, the buffering mechanism, which assembles the upstream rotating member, the buffering member, and the downstream rotating member, can be made compact in the axial direction.

According to other features of the present disclosure, the upstream rotating member has an upstream disc portion that covers the buffering member in the axial direction. The downstream rotating member has a downstream disc portion that covers the buffering member from the opposite side of the upstream disc portion. Therefore, by clamping the buffering member between the upstream disc portion and the downstream disc portion during assembly, the buffering member can be properly positioned in the axial direction.

According to other features of the present disclosure, the buffering member has a protrusion projecting in the axial direction. The protrusion elastically contacts the upstream disc portion or the downstream disc portion. Therefore, the protrusion of the buffering member biases the upstream disc portion or the downstream disc portion in the axial direction. A small space is provided between the upstream rotating member or the downstream rotating member and the mechanism housing in the axial direction such that the upstream rotating member and the downstream rotating member can rotate. The axial biasing force of the protrusion can suppress the axial play of the upstream or downstream rotating member.

According to other features of the present disclosure, the driving mechanism has a piston and an accumulation chamber. The piston is movable together with the driver. The accumulation chamber is pressurized by a backward movement of the piston. For example, the lifter may receive an impacted when the driver moves rearward or the driving operation of the driver is performed. In addition, if a misalignment occurs between the lifter and the driver, there is a risk that the lifter may come into contact with the driver as it moves forward, causing an impact. In the so-called gas spring type driving tool, the present disclosure prevents the impact on the lifter side from being transmitted to the upstream electric motor and power transmission path.

According to other features of the present disclosure, a planetary reduction mechanism, a bevel gear unit (bevel gear assembly), and a buffering member are positioned in the power transmission path. The planetary reduction mechanism reduces the output of the electric motor. The bevel gear unit changes the direction of the output of the electric motor. Accordingly, an upstream rotating member is positioned between the electric motor and the buffering member. When the upstream rotating member rotates forward by receiving the output of the electric motor, the buffering member transmits the rotational power of the upstream rotating member to the downstream rotating member while absorbing the impact. Therefore, the output of the electric motor can be reliably transmitted to the lifter. Furthermore, when an impact is transmitted from the lifter to the downstream rotating member, the impact is absorbed by the buffering member before it is transmitted to the upstream rotating member, because the buffering member is always interposed between the downstream rotating member and the upstream rotating member. This prevents the impact from being transmitted to the electric motor and power transmission path located upstream from the buffering member.

According to other features of the present disclosure, the bevel gear unit is positioned downstream of the planetary reduction mechanism. The upstream rotating member, the downstream rotating member, and the buffering member are positioned downstream of the planetary reduction mechanism and upstream of the bevel gear unit. Therefore, the upstream rotating member, the downstream rotating member, and the buffering member can be located downstream of the planetary reduction mechanism. Therefore, the upstream rotating member, the downstream rotating member, and the buffering member can be assembled together with the planetary reduction mechanism. This improves the workability of the assembly work. In addition, by arranging the upstream rotating member, the downstream rotating member, and the buffering member upstream of the bevel gear unit, the design flexibility is improved. For example, the bevel gear unit and the lifter can be positioned closer together along the lifter axis.

According to other features of the present disclosure, a stopper for restricting reverse rotation of the planetary reduction mechanism is arranged in the power transmission path. A holding member of the buffering member serves as a structural component of the stopper. Therefore, the buffering mechanism including the buffering member and the stopper can be compactly installed.

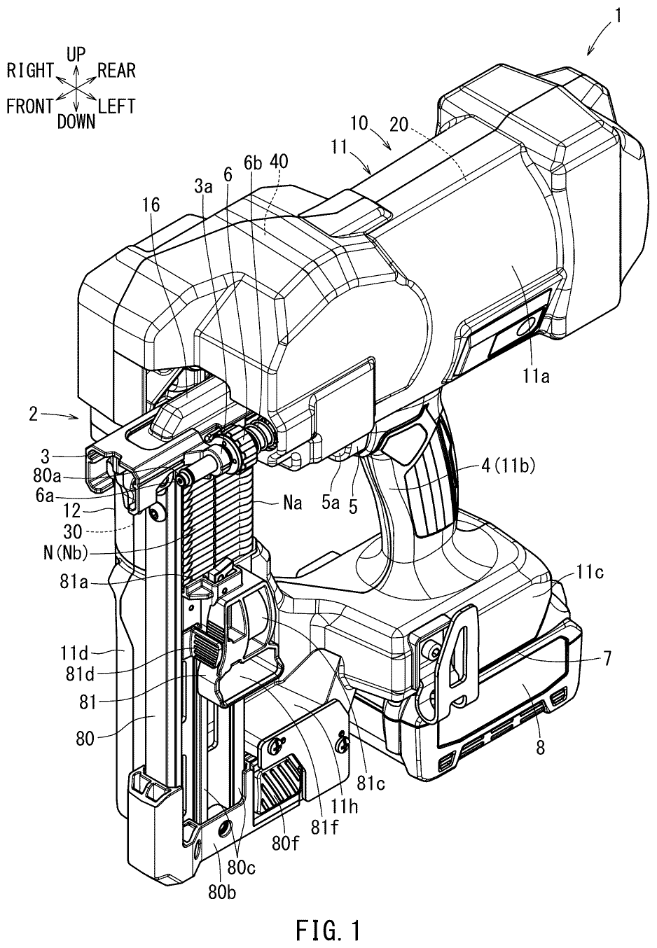

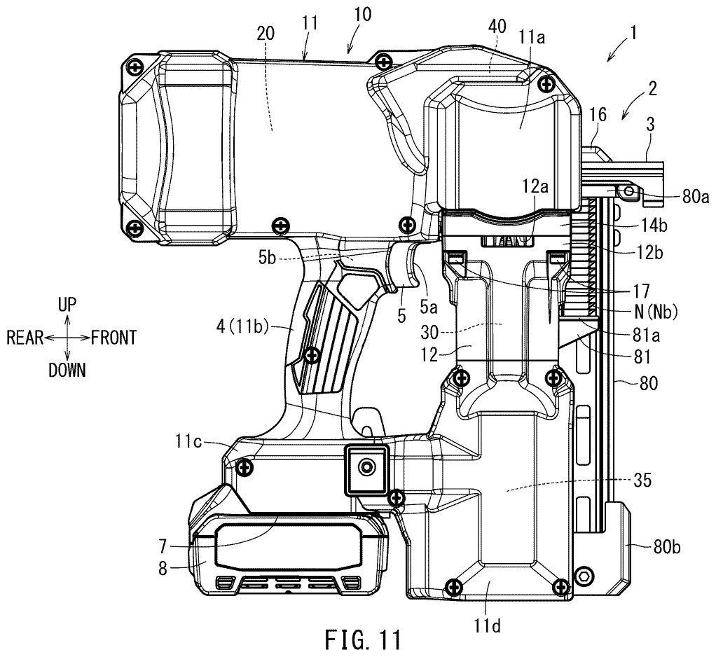

Next, a first embodiment of the present disclosure will be described with reference to FIGS. 1 to 20. As an example of a driving tool, a gas spring type driving tool 1, which uses a pressure of the gas filled in an accumulation chamber as the driving force for driving a driving member, is illustrated. The driving tool 1 shown in the embodiment is a fencing stapler that drives staples (driving members N) into wooden posts, etc. The driving tool 1 can be used to attach a fence including metal wires to the post together with staples. In the following description, the driving direction of the driving member N is defined as a forward direction, and a direction opposite to the driving direction is defined as a rearward direction. A user of the driving tool 1 generally stands behind the driving tool 1 to hold the handle 4. An upper, lower, leftward, and rightward directions are defined based on the user's position.

### <Overall Structure of the Driving Tool 1>

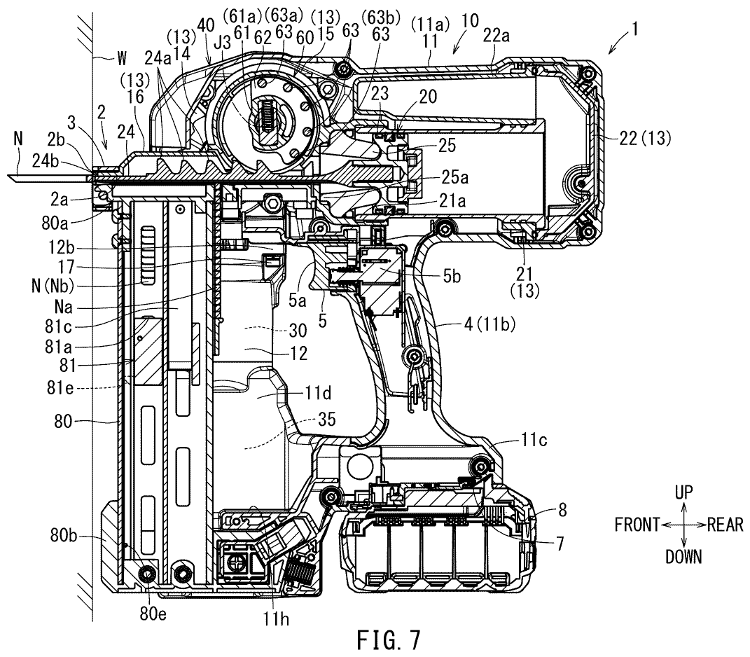

As shown in FIG. 1, the driving tool 1 has a tool main body 10 and a handle 4. The handle 4 extends downward from the tool main body 10. The tool main body 10 is provided with a driving mechanism 20, an electric motor 30, and a power transmission mechanism 40. The driving mechanism 20 moves the driver 24 (see FIG. 7) forward in a driving direction. The power transmission mechanism 40 transmits an output of the electric motor 30 to the driver 24. A lifter 60 (see FIG. 7) is arranged at the lowermost downstream end of the power transmission mechanism 40. The lifter 60 moves the driver 24 rearward in a direction opposite to the driving direction by receiving the output of the electric motor 30.

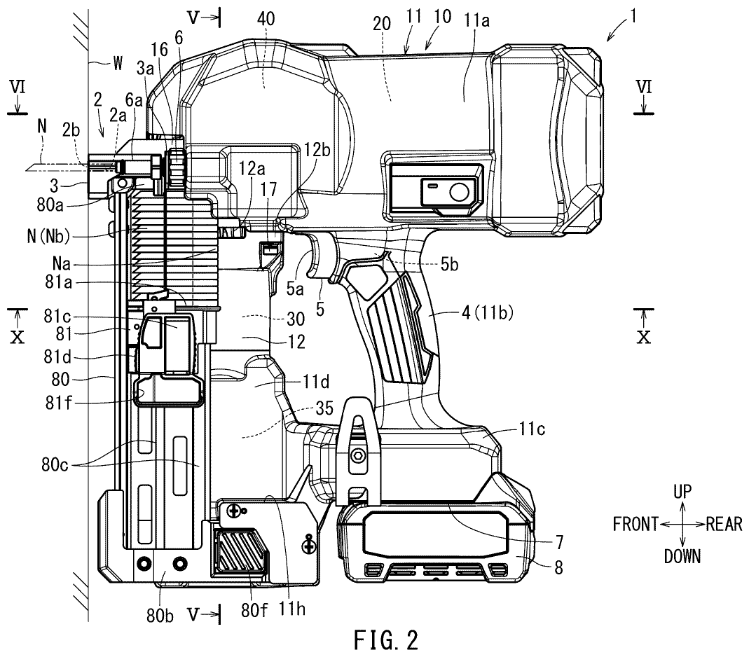

As shown in FIG. 2, a trigger 5 is positioned at the front upper portion of the handle 4. The trigger 5 has an operating surface 5a located at its front portion. A trigger switch 5b is situated inside the handle 4 behind the trigger 5. A user can hook a finger on the operating surface 5a while gripping the handle 4. The user can push toward the handle 4 (rearward) with the finger hooked on the operating surface 5a. This action pushes the trigger switch 5b via the trigger 5, switching the trigger switch 5b from an off state to an on state. When in the on state, the trigger switch 5b transmits an on signal to the controller 35. The operation of the trigger 5 only becomes effective when the driving nose 2 is pressed against a workpiece W, causing the driving nose 2 to move rearward.

As shown in FIG. 2, a main body housing 11 covers the driving mechanism 20 and the power transmission mechanism 40. The main body housing 11 is made of, for example, synthetic resin. The main body housing 11 includes an upper housing 11a, a handle housing 11b, and a lower housing 11d. The upper housing 11a covers the driving mechanism 20 and at least a part of the power transmission mechanism 40. The handle housing 11b is tubular and extends downward from the upper housing 11a. The handle housing 11b forms an outer circumferential surface of the handle 4. An expanded portion 11c is connected to a lower portion of the handle housing 11b. The expanded portion 11c has a rectangular box shape with a width in both the front-rear direction and left-right directions greater than that of the handle housing 11b.

As shown in FIG. 2, a battery attachment portion 7 is arranged on the lower surface of the expanded portion 11c. The battery 8 can be detachably attached to the battery attachment portion 7. The battery 8 is attached to the battery attachment portion 7 by sliding the battery 8 from the rear to the front. On the other hand, the battery 8 is detached from the battery attachment portion 7 by sliding the battery 8 from the front to the rear. The battery 8 is located below the battery attachment portion 7 when attached to the battery attachment portion 7. The battery 8 supplies power to the electric motor 30 and other electric components. The battery 8 removed from the battery attachment portion 7 can be recharged by a dedicated charger for repeated use. The battery 8 can be used as a power source for other driving tools.

As shown in FIG. 2, the lower housing 11d is connected to a front portion of the expanded portion 11c of the handle housing 11b. The lower housing 11d is connected to a lower portion of the motor housing 12 that houses the electric motor 30. The lower housing 11d mainly houses a controller 35 that controls driving of the electric motor 30. An overall shape of the main body housing 11, which is connected to the upper housing 11a, the handle housing 11b, and the lower housing 11d, is C-shaped when viewed in the left-right direction. The motor housing 12 is located within the C-shaped opening of the main body housing 11 when viewed in the left-right direction.

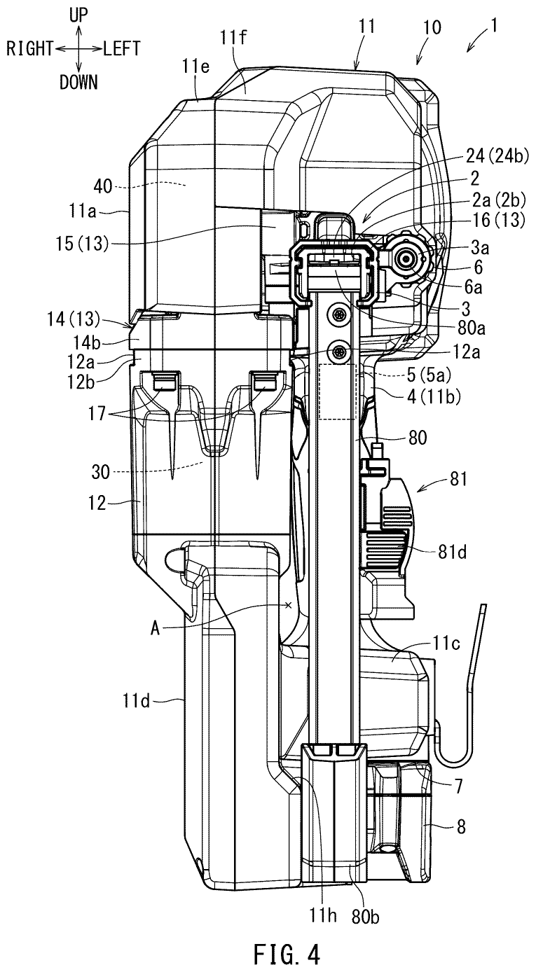

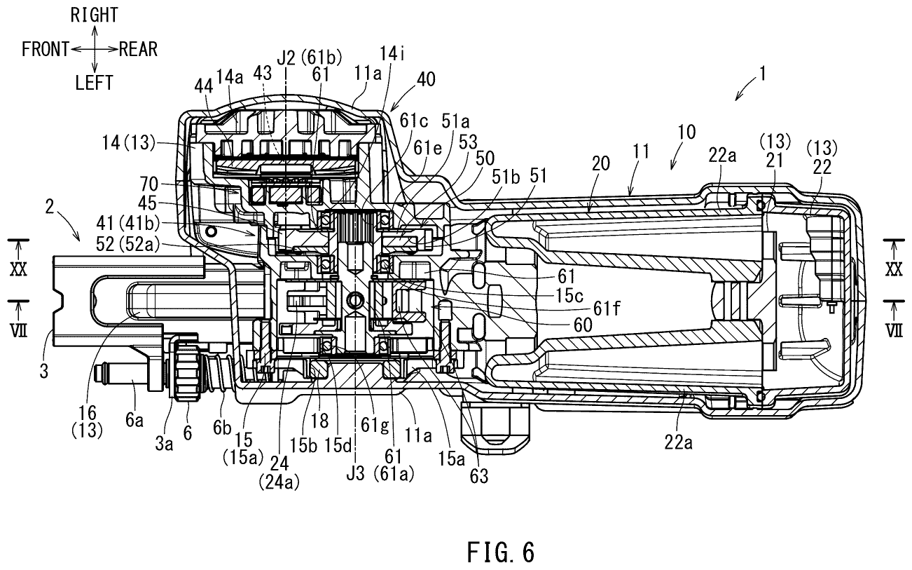

As shown in FIG. 4, the handle 4 and the trigger 5 are located at substantially the same position as the magazine 80 in the left-right direction. The lateral centers of the handle 4, the trigger 5, and the magazine 80 are approximately aligned, and for example, they are substantially aligned with the lateral center of the cylinder 21 (see FIG. 6). The handle 4 and the magazine 80 extend in the up-down direction and substantially parallel to each other. The motor housing 12 is located rightward of the trigger 5 and the magazine 80, and spaced apart from the trigger 5 and the magazine 80 in the left-right direction. The upper portion of the motor housing 12 slightly overlaps the handle 4 in the left-right direction, but the lower portion of the motor housing 12 is spaced apart from an outer surface of the handle 4 in the left-right direction. There is a space A between the motor housing 12 and the handle 4 in the left-right direction when viewed from the front.

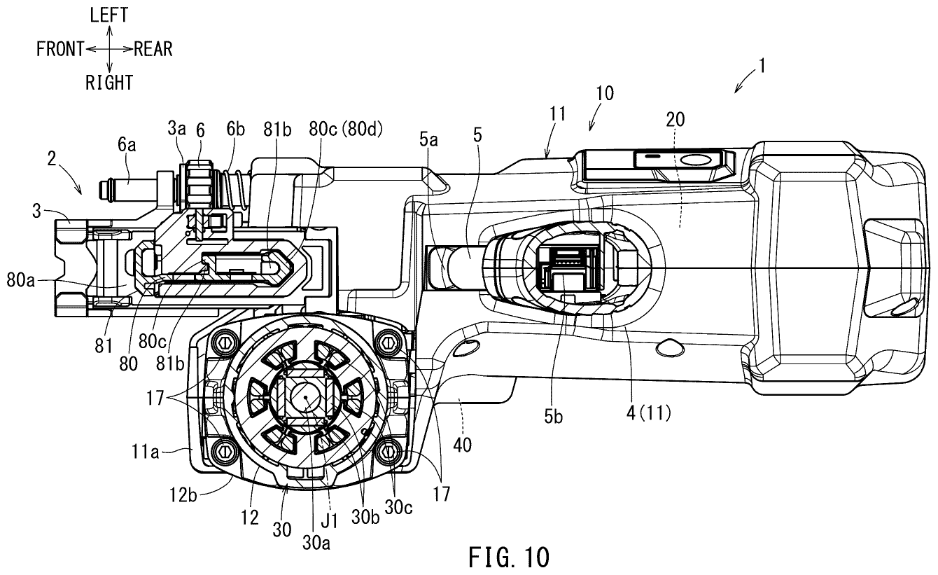

As shown in FIG. 2, the motor housing 12 is arranged adjacent to the magazine 80 in the left-right direction and overlaps with the magazine 80 in the front-rear direction. A rear end of the motor housing 12 is located forward of the operating surface 5a of the trigger 5 in the front-rear direction. As shown in FIG. 10, the motor housing 12 is located to the right of a region between the magazine 80 and the trigger 5 in the front-rear direction.

As shown in FIG. 2, a driving nose 2 is arranged at the front end of the tool main body 10. The driving nose 2 has a driver guide 16 that extends in the front-rear direction. A driving passage 2a that extends in the front-rear direction is arranged within the driver guide 16. An ejection port 2b opens toward the front at the front end of the driving passage 2a.

As shown in FIG. 2, the driving nose 2 has a contact arm 3 that contacts the workpiece W. The contact arm 3 is slidable in the front-rear direction relative to the driver guide 16. The contact arm 3 connects to the adjuster 6 via an adjuster connecting portion 3a. The adjuster 6 is arranged on the left side of the driving nose 2. The adjuster 6 is rotatable around an axis of the rotation shaft 6a that extends in the front-rear direction. By rotating the adjuster 6, the position of the contact arm 3 relative to the driver guide 16 can be adjusted in the front-rear direction.

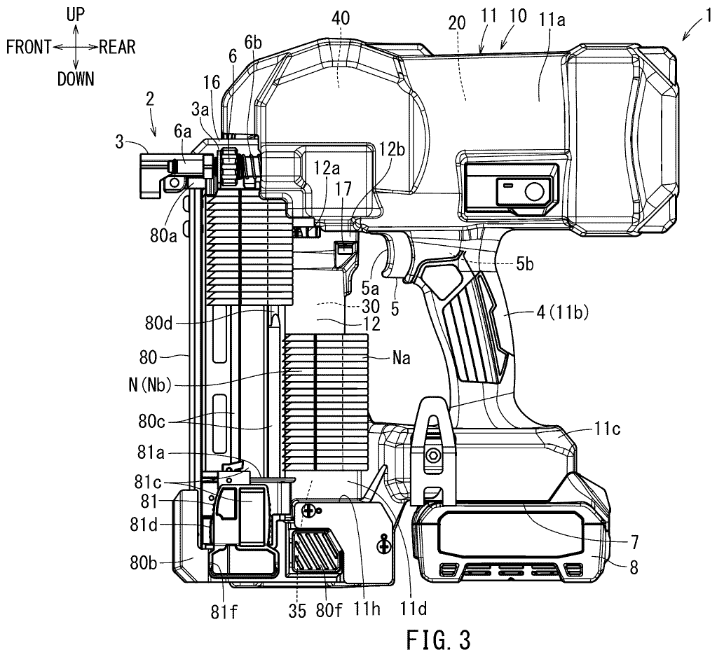

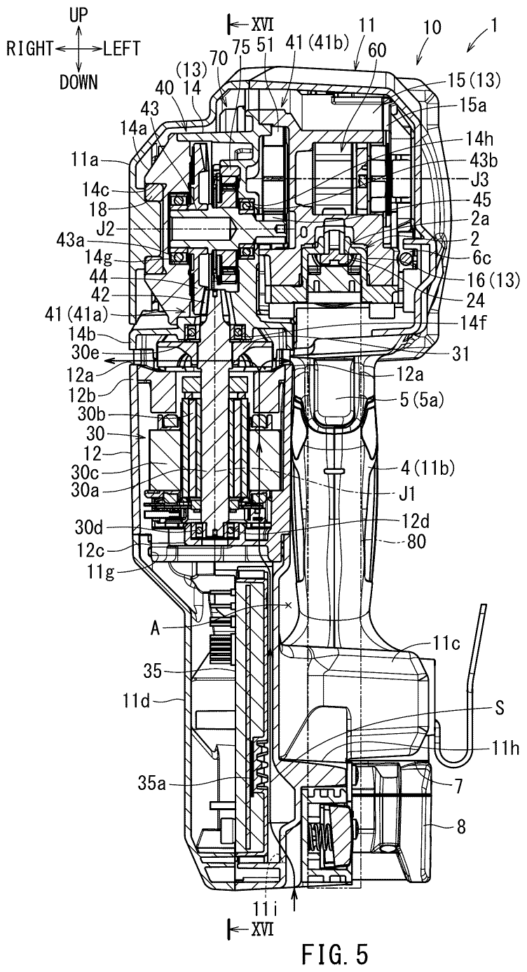

As shown in FIG. 3, the adjuster 6 is biased forward relative to the driver guide 16 by a compression spring 6b. The contact arm 4 that connects to the adjuster 6 is also biased forward relative to the driver guide 16 by the compression spring 6b. A switch 6c is arranged behind the adjuster 6 (refer to FIG. 5). As shown in FIG. 2, the contact arm 3 and the adjuster 6 move rearward when the contact arm 3 is pressed against the workpiece W. The switch 6c is actuated from an off state to an on state by being pressed, either directly or indirectly via a spring or the like against the adjuster 6. When switch 6c is in the on state, it transmits an on signal to the controller 35. When the on signal from switch 6c is transmitted to controller 35, a pulling operation of the trigger 5 becomes effective. When contact arm 3 is not pressed against workpiece W, the switch 6c is in the off state and does not transmit the on signal. Therefore, the pulling operation of the trigger 5 is not effective.

### <Driving Mechanism 20>

As shown in FIG. 7, the driving mechanism 20 has a cylinder 21, a piston 23, and a driver 24. The cylinder 21 is housed in the main body housing 11 and extends in the front-rear direction. The piston 23 can reciprocate within the cylinder 21 in the front-rear direction. The driver 24 connects to the front surface of the piston 23 and extends in the front-rear direction. A rear end of the cylinder 21 connects to an accumulation chamber 22 at the rear of the piston 23. The accumulation chamber 22 is filled with a compressed gas such as air. The gas pressure in the accumulation chamber 22 acts as a thrust force on the rear surface of the piston 23, pushing it forward.

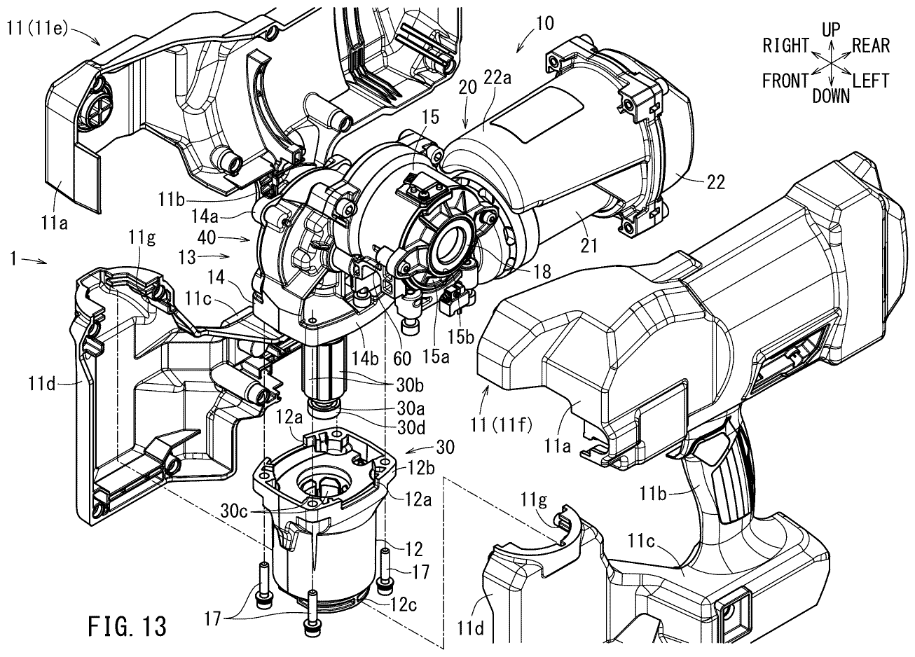

As shown in FIG. 7, the accumulation chamber 22 connects to an air chamber 22a above the cylinder 21. The air chamber 22a extends forward from the rear end of the cylinder 21. The air chamber 22a extends to an adjoining area of the rear end of the lifter 60. The air chamber 22a extends forward to a position approximately the same as the front end of the piston 23 when it is at the bottom dead center. The air chamber 22a is located behind the lifter 60. The height of the upper end of the air chamber 22a is approximately the same as the upper end of the lifter 60. As shown in FIG. 13, a lower surface of the air chamber 22a is formed in an arc shape to cover the outer circumferential surface of the cylinder 21 from above. The upper surface of the air chamber 22a is formed in an arc shape to follow the inner circumferential surface of the upper housing 11a.

As shown in FIG. 7, a tubular damper 25 is arranged at the front of the cylinder 21. The damper 25 is made of an elastic material such as rubber. The damper 25 absorbs the forward impact of the piston 23 when the piston 23 moves to the bottom dead center during the driving operation. The driver 24 is inserted through the center of the damper 25. A front end 25a of the damper 25 is located forward of the front end 21a of the cylinder 21. Furthermore, the front end 25a of the damper 25 is located rearward of the rear end of the lifter housing 15 and at approximately the same position as the rear end of the lifter 60 in the front-rear direction. The front end 25a of the cushion 25 and the front end 21a of the cylinder 21 are located rearward of the operating surface 5a of the trigger 5. The front end of the piston 23 at the bottom dead center is also located rearward of the operating surface 5a of the trigger 5.

As shown in FIG. 7, a plurality of rack teeth 24a projecting upward are arranged on the upper surface of the driver 24. In this embodiment, five rack teeth 24a are arranged in the front-rear direction, which is the longitudinal direction of the driver 24. The rack teeth 24a are triangular in shape when viewed from the left or right side. The front surface of the rack teeth 24a extends in a direction substantially perpendicular to the driving direction. The rear surface of the rack teeth 24a extends in a direction inclined forward toward the upper side. The rack teeth 24a are one example of engaged portions that engage the engaging pins (engaging portions) 63 of the lifter 60. When the lifter 60 rotates, the bottom surface of each rack teeth 24a engages a corresponding engaging pin 63. As a result, the driver 24 and the piston 23 move rearward against the gas pressure in the accumulation chamber 22.

Referring to FIG. 2, a driving member N housed in the magazine 80 is sequentially supplied to the driving passage 2a by a pusher 81. The driving member N is supplied to the driving passage 2a in a posture in which the head Na is located at the rear end and the legs Nb extend forward from the left and right ends of the head Na. Referring to FIG. 7, the driver 24 moves forward owing to the gas pressure in the accumulation chamber 22 during the driving operation. The tip end 24b located at the front end of the driver 24 moves forward and strikes (drives) the head Na of a single driving member N supplied to the driving passage 2a. As a result, the driving member N ejects from the ejection port 2b and is driven into the workpiece W.

### <Mechanism Unit 13>

As shown in FIG. 5, the tool main body 10 includes a gear housing 14 and a lifter housing 15 as a mechanism housing for housing the power transmission mechanism 40. The gear housing 14 houses a speed reduction mechanism 41 for reducing the output of the electric motor 30 in the power transmission mechanism 40. The lifter housing 15 houses the lifter 60 of the power transmission mechanism 40. The gear housing 14 is covered by the main body housing 11 except for a fastened portion 14b located at the bottom. An entirety of the lifter housing 15 is covered by the main body housing 11.

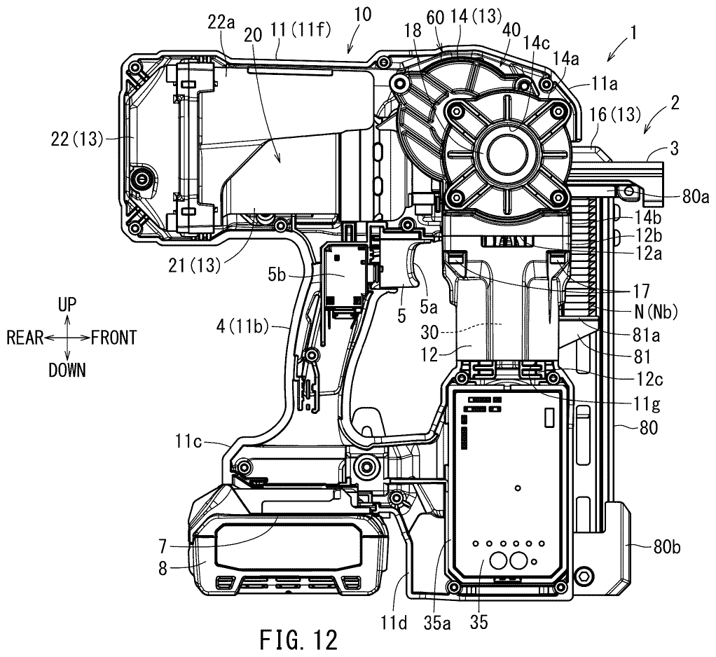

Referring to FIG. 13, the gear housing 14, the lifter housing 15, the cylinder 21, and the accumulation chamber 22 are integrally connected by screw fastening. Although omitted in FIG. 13 for clarity, the driver guide 16 and the cylinder 21 are also screw-fastened to the lifter housing 15 (refer to FIG. 12). In the present disclosure, a structure including the gear housing 14, the lifter housing 15, the driver guide 16, the cylinder 21, and the accumulation chamber 22 is referred to as the mechanism unit 13. Each structure forming the mechanism unit 13 is made of a material, such as aluminum or iron, having higher rigidity than the main body housing 11. Vibrations generated within the mechanism unit 13, such as those generated by sliding of the piston 23 and the movement of the driver 24, are transmitted throughout the mechanism unit 13 in the same vibration mode (refer to FIG. 7). The mechanism unit 13 is mostly covered by the upper housing 11a.

As shown in FIG. 12, a cap 14a is screw-fastened to the right side of the gear housing 14. The cap 14a covers the gear housing 14 in an airtight manner. A tubular ring holding portion 14c is recessed on the outer surface of the cap 14a (refer to FIG. 5). A rubber ring 18 is placed on the ring holding portion 14c as an elastic member. The rubber ring 18 is elastically held between the ring holding portion 14c on the outer surface of the cap 14a and the inner surface of the upper housing 11a (see FIG. 5). Accordingly, the rubber ring 18 reduces vibration transmission from the gear housing 14 to the main body housing 11.

As shown in FIG. 13, a cap 15a is screw-fastened to the left side of the lifter housing 15. The cap 15a covers the lifter housing 15 in an airtight manner. A tubular ring holding portion 15b is recessed on the outer surface of the cap 15a. A rubber ring 18 is placed on the ring holding portion 15b as an elastic member. The rubber ring 18 is elastically held between the ring holding portion 15b on the outer surface of the cap 15a and the inner surface of the upper housing 11a (see FIG. 6). Accordingly, the rubber ring 18 reduces vibration transmission from the lifter housing 15 to the main body housing 11.

### <Electric Motor 30, Motor Housing 12, and Surrounding Structure>

As shown in FIG. 5, a motor shaft 30a is arranged in the center of the electric motor 30. The motor shaft 30a extends in the up-down direction along the motor axis J1. The motor shaft 30a is rotatably supported by the bearing 30d at its lower end and by the bearing 30e at its upper end. The bearing 30d is inserted into the recess 12d formed in the lower portion of the motor housing 12. The bearing 30e is press-fitted into the recess 14f formed in the lower portion of the gear housing 14. A rotor 30b is integrally attached to the outer circumference of the motor shaft 30a. Therefore, the motor shaft 30a and the rotor 30b are supported by the gear housing 14 (refer to FIG. 13). Accordingly, vibrations of the mechanism unit 13 are transmitted to the motor shaft 30a and the rotor 30b.

As shown in FIGS. 4 and 12, the motor housing 12 is formed in a tubular shape and extends in the up-down direction. The motor housing 12 is made of a material that is more rigid than the main body housing 11, for example, a synthetic resin. A flange-shaped and rectangular tubular-shaped fastening portion 12b is formed at the upper portion of the housing 12, projecting radially outward from the tubular portion. As shown in FIG. 5, the stator 30c is fixed to the inner circumferential surface of the motor housing 12. The stator 30c is located radially outward from the rotor 30b.

As shown in FIGS. 4 and 12, a flange-shaped and rectangular tubular-shaped fastened portion 14b is formed at the lower portion of the gear housing 14. The fastened portion 14b has an outer peripheral shape that is substantially the same as that of the fastening portion 12b of the motor housing 12. The fastened portion 14b is exposed outside from the upper housing 11a. The fastening portion 12b of the motor housing 12 and the fastened portion 14b of the gear housing 14 are screw-fastened by bolts 17. The bolts 17 are fastened from the lower fastening portion 12b toward the upper fastened portion 14b. By screw-fastening of the motor housing 12 and the gear housing 14, vibrations with the same vibration mode as those of the mechanism unit 13 are transmitted to the motor housing 12 and the stator 30c.

As shown in FIG. 13, the outer periphery of the lower portion of the motor housing 12 has a connected portion 12c, which is provided with a groove extending in the circumferential direction. A connecting portion 11g, provided with a rib extending in the circumferential direction, is formed on the inner periphery of the upper portion of the lower housing 11d. The connecting portion 11g is engageable with the connected portion 12c. The main body housing 11 has a split structure divided in the left-right direction into a right housing 11e and a left housing 11f. The connected portion 12c of the motor housing 12 is sandwiched (clamped) between the divided left and right lower housings 11d. Because of this configuration, the connecting portion 11g engages the connected portion 12c, thereby positioning the motor housing 12 and the lower housing 11d relative to each other in the up-down direction.

As shown in FIG. 5, a fan 31 is attached to the upper portion of the motor shaft 30a. The fan 31 is located immediately below the bearing 30e and above the rotor 30b. The fan 31 rotates integrally with the motor shaft 30a to generate cooling air flowing upward from the lower portion to the upper portion of the motor housing 12. As shown in FIG. 4, exhaust holes 12a penetrating through both the inside and outside of the motor housing 12 are formed on the left and right sides of the fastening portion 12b of the motor housing 12. The exhaust holes 12a are located at substantially the same position as the fan 31 in the up-down direction. The upper end of the exhaust holes 12a is formed by the lower surface of the fastened portion 14b of the gear housing 14.

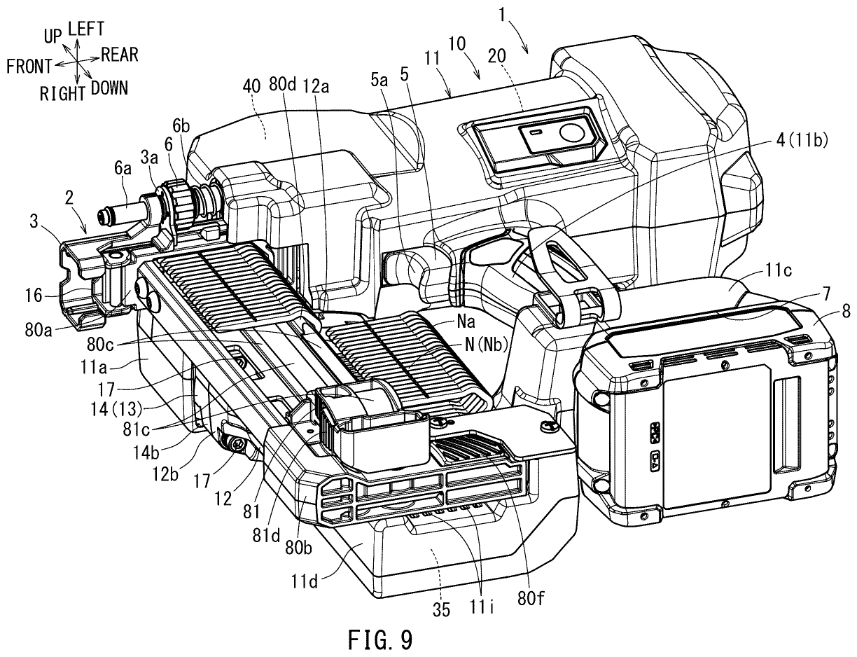

As shown in FIG. 12, a controller 35 is housed in the lower housing 11d. The controller 35 mainly controls the drive operation of the electric motor 30. The controller 35 is provided with a control board housed in a shallow rectangular box-shaped case 35a. The case 35a is made of, for example, aluminum having good heat conductivity. The controller 35 is housed in the lower housing 11d such that its longitudinal direction is directed in the up-down direction and the bottom surface (wide surface) of the case 35a is located to the left. The longest side of the controller 35 extends in the up-down direction and the shortest side extends in the left-right direction. As shown in FIG. 9, a ventilation hole 11i is located on the left side of the lower portion of the lower housing 11d, penetrating the lower housing 11d from the inside to the outside. The ventilation hole 11i is located so as to face the right side of the magazine 80 with a space in the left-right direction.

As shown in FIG. 5, an air passage S through which cooling air flows from the ventilation hole 11i to the exhaustion hole 12a is provided in the lower housing 11d and the motor housing 12. The air passage S extends upwardly between the left inner surface of the lower housing 11d and the bottom outer surface (wide surface) of the case 35a of the controller 35, starting from the air inlet 11i where outside air flows in. The air passage S extends further upward toward the motor housing 12 at the connecting portion between the lower housing 11d and the motor housing 12. When it reaches the fan 31, the cooling wind is discharged to the outside through the exhaustion hole 12a on the radial outer side of the fan 31. By the cooling wind flowing through the air passage S, the controller 35 and the motor 30 can be cooled.

### <Speed Reduction Mechanism 41>

As shown in FIG. 5, a speed reduction mechanism 41 is arranged above the electric motor 30. In this embodiment, the speed reduction mechanism 41 reduces the output of the electric motor 30 in two stages, an upstream speed reduction section 41a and a downstream speed reduction section 41b. A driving bevel gear 42 is arranged at the upper end of the motor shaft 30a. The driving bevel gear 42 is arranged immediately above the bearing 30e. This reduces the wobble of the driving bevel gear 42 relative to the bearing 30e when the driving bevel gear 42 rotates around the motor axis J1. Because of this configuration, engagement precision of the driving bevel gear 42 can be maintained. A driven bevel gear 44 engaging the driving bevel gear 42 is located to the right and above the driving bevel gear 42. The upstream speed reduction section 41a includes the driving bevel gear 42 and the driven bevel gear 44.

As shown in FIG. 5, the driven bevel gear 44 is integrally connected to an intermediate shaft 43. The intermediate shaft 43 extends in the left-right direction along an intermediate axis J2 that is perpendicular to the motor axis J1. The intermediate shaft 43 is rotatably supported around its axis via the bearings 43a and 43b. The bearing 43a is connected to the right end of the intermediate shaft 43. The bearing 43a is inserted into a recess 14g provided on the left side of the cap 14a. The driven bevel gear 44 is disposed immediately to the left of the bearing 43a. This reduces the wobble of the driven bevel gear 44 relative to the bearing 43a when the driven bevel gear 44 rotates around the axis of the intermediate shaft J2. Because of this configuration, engagement precision of the driven bevel gear 44 can be maintained. The bearing 43b connects to the left side of the intermediate shaft 43. The bearing 43b is press-fitted into a recess 14h provided on the inner side (right side) of the left side of the gear housing 14.

As shown in FIG. 5, a stopper 70 is positioned along the intermediate shaft 43, approximately in the middle of its length in the left-right (axial) direction. The stopper 70 regulates the rotation of the intermediate shaft 43 as it is configured to allow rotation in the forward rotation direction and to restrict rotation in the reverse rotation direction. The stopper 70 is located on the left side of the driven bevel gear 44 and immediately to the right of the bearing 43b. The stopper 70 overlaps the driving bevel gear 42 in the left-right direction by a length equal to at least half of the overall left-right width of the stopper 70 on the upper side of the driving bevel gear 42 and along (an extension line of) the motor axis J1. A driving spur gear (downstream driving gear) 45 is disposed at the left end of the intermediate shaft 43. The driving spur gear 45 is disposed to the left of the bearing 43b. The stopper 70 and the driving bevel gear 42 are situated between the driven bevel gear 44 and the driving spur gear 45 in the left-right direction. The intermediate shaft 43, the driven bevel gear 44, and the driving spur gear 45 all rotate integrally around the intermediate axis J2.

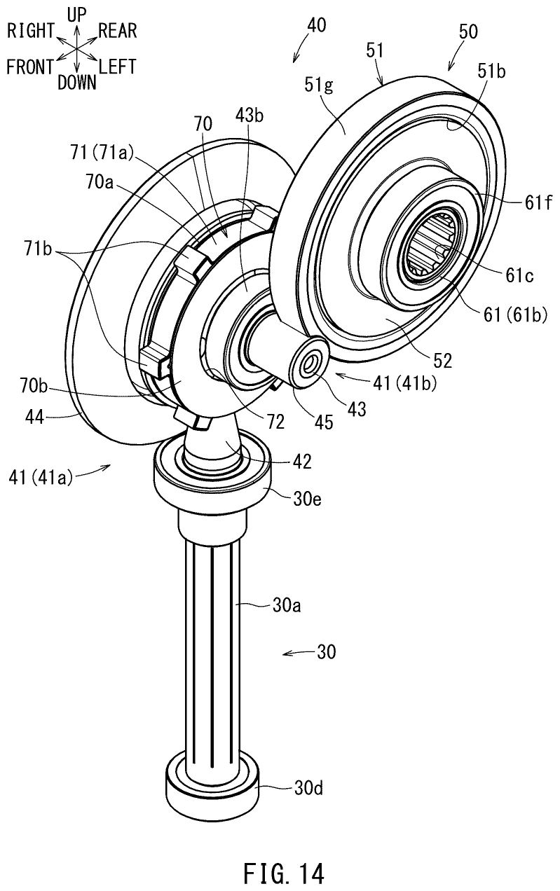

As shown in FIGS. 5 and 14, a washer 70a is disposed immediately to the right of the stopper 70. A washer 70b is disposed immediately to the left of the stopper 70. In other words, the stopper 70 is positioned between the left washer 70a and the right washer 70b.

As shown in FIG. 5, a driven spur gear 51 is disposed rearwardly and upwardly of the driving spur gear 45. The engagement between the driving spur gear 45 and the driven spur gear 51 forms a downstream speed reduction section 41b. Since the driven spur gear 51 is a speed reduction gear at the downstream end of the speed reduction mechanism, it is the final driven gear in this disclosure. As shown in FIG. 6, the driven spur gear 51 is rotatable around a lifter axis J3. The lifter axis J3 extends in the left-right direction, parallel to the intermediate axis J2, and is situated on the rear upper side of the intermediate axis J2. The driven spur gear 51 connects to the driving ring 52 via a buffering member 53. The buffering mechanism 50 includes the driven spur gear 51, the driving ring 52, and the buffering member 53. The driving ring 52 is rotatable around the lifter axis J3 together with the lifter shaft 61. Because of this configuration, the output of the electric motor 30 is reduced in the upstream speed reduction section 41a, and its direction of rotation is changed. Furthermore, the output of the electric motor 30 is further reduced in the downstream speed reduction section 41b and transmitted to the lifter shaft 61.

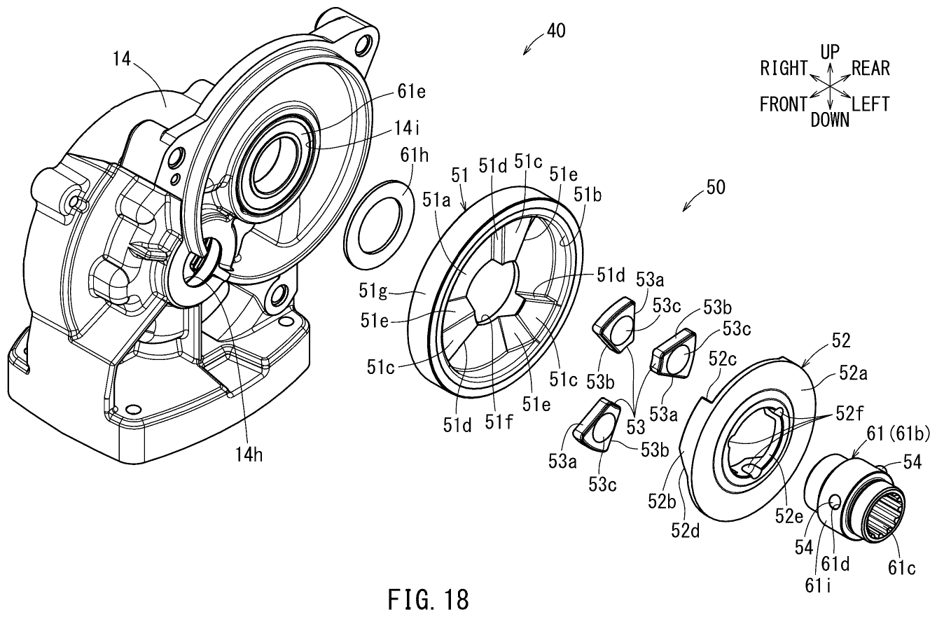

As shown in FIG. 6, the lifter shaft 61 is rotatably supported around the lifter axis J3 by three bearings 61e, 61f, and 61g. The bearing 61e connects to the right end of the lifter shaft 61. The bearing 61e is inserted into a recess 14i provided on the outside (left side) of the left-side surface of the gear housing 14. The driven spur gear 51 is located immediately to the left of the bearing 61e. A washer 61h (refer to FIG. 18) is positioned between the bearing 61e and the driven spur gear 51. The bearing 61f connects to the lifter shaft 61 approximately in the middle of the lifter shaft 61 in the left-right direction. The bearing 61f is located immediately to the left of the driven spur gear 51 and the driving ring 52. The bearing 61f is press-fitted into a recess 15c provided on the outside (right side) of the right-side surface of the lifter housing 15. The bearing 61g connects to the left end of the lifter shaft 61. The bearing 61g is inserted into a recess (not shown) on the right-side surface of the cap 15a. The lifter 60 is positioned axially (in the left-right direction) between the bearing 61f and the bearing 61g.

### <Lifter>

As shown in FIG. 7, the lifter 60 is located above the driver 24. A front end of the lifter 60 is located at approximately the same position as the rear end of the magazine 80 in the front-rear direction. The front end of the lifter housing 15 overlaps the magazine 80 in the front-rear direction. The rear end of the lifter 60 is located rearward of at least a part of the operating surface 5a of the trigger 5. The rear end of the lifter housing 15 is located rearward of the operating surface 5a of the trigger 5. The lifter 60 has a wheel 62 and a plurality of engaging pins (engaging portions) 63. The wheel 62 rotates in a counterclockwise direction in FIG. 7 when the lifter shaft 61 rotates around the lifter axis J3.

As shown in FIG. 7, a plurality of engaging pins 63 are arranged along an outer circumferential edge of the wheel 62. In this embodiment, five engaging pins 63 are arranged at substantially constant intervals in the circumferential direction of the wheel 62. The number of engaging pins 63 is the same as that of the rack teeth 24a provided on the driver 24. Each engaging pin 63 has a cylindrical shape, with its axis extending in the lateral direction. Each engaging pin 63 is held on the wheel 62 so as to be rotatable around its axis. The plural engaging pins 63 include a first engaging pin 63a and a last engaging pin 63b. The first engaging pin 63a is disposed at the leading end (frontmost position) in the rotational direction of the wheel 62 (counterclockwise direction in FIG. 7), while the last engaging pin 63b is disposed at the trailing end (rearmost position) in the same rotational direction.

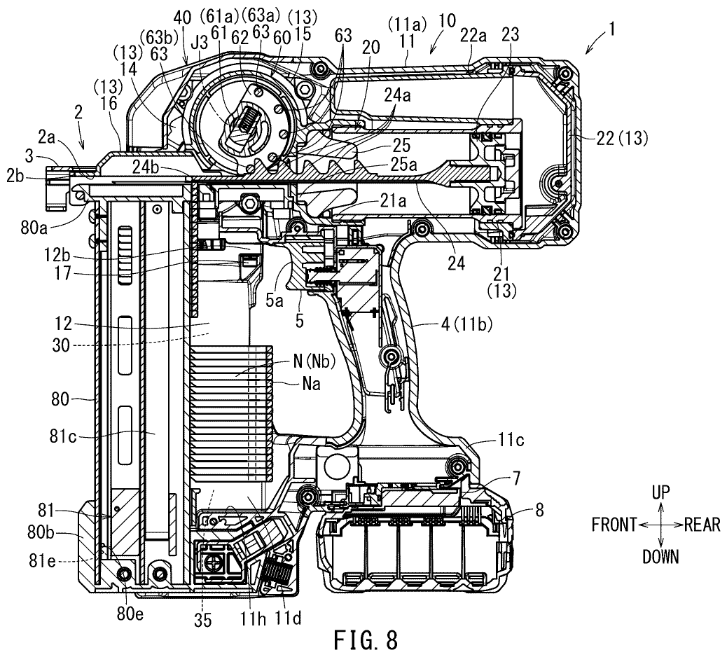

Referring to FIGS. 7 and 8, the first engaging pin 63a engages the bottom surface (front surface) of the rearmost rack tooth 24a among the plurality of rack teeth 24a during the normal operation. The last engaging pin 63b engages the bottom surface of the foremost rack tooth 24a among the plurality of rack teeth 24a during the normal operation. Each engaging pin 63 pushes the bottom surface of the corresponding rack tooth 24a in the rearward direction when the wheel 62 rotates in the counterclockwise direction in the figure. Because of this configuration, the driver 24 moves from the bottom dead center to the standby position and to the top dead center against the gas pressure in the accumulation chamber 22.

In the case of an abnormal operation where the driver 24 cannot be driven to the bottom dead center due to, for example, a nail jamming in the driving passage 2a, there may be a misalignment in which, for example, the first engaging pin 63a engages a second rack tooth 24a adjacent to the rearmost rack tooth. In such a case, after the nail jamming is cleared, the driver 24 moves to the bottom dead center during the next driving operation, thereby returning to the normal operation where the first engaging pin 63a engages the rearmost rack tooth 24a.

As shown in FIG. 7, the wheel 62 has a fan-shaped profile when viewed from the left or right side. A central angle of the fan-shaped wheel 62 is less than 180°. The outer diameter of the wheel 62 is such that the central angle of the fan shape is less than 180° and the circumferential distance from the first engaging pin 63a to the last engaging pin 63b is set to be equal to the distance from the rearmost rack tooth 24a to the foremost rack tooth 24a in the front-rear direction.

### <Stopper 70>

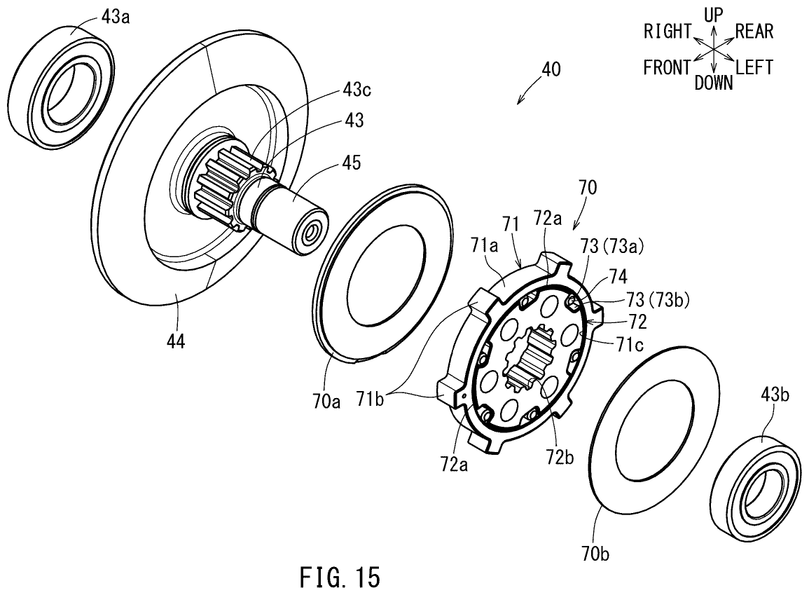

As shown in FIG. 15, the stopper 70 has a cylindrical outer ring 71 and a cylindrical inner ring 72. The inner ring 72 is housed on the inner circumferential side of the outer ring 71. The inner circumferential surface 71c of the outer ring 71 and the outer circumferential surface 72a of the inner ring 72 face each other with a slight radial clearance. The outer ring 71 and the inner ring 72 have approximately the same width in the axial (left-right) direction.

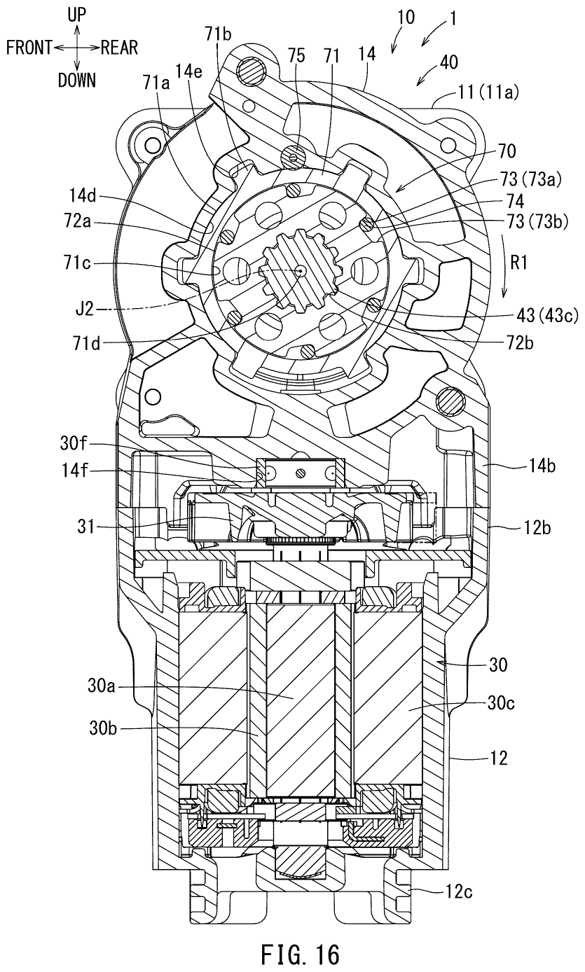

As shown in FIG. 15, a plurality of projections 71b projecting radially outward are formed on the outer circumferential surface 71a of the outer ring 71. The plurality of projections 71b are formed, for example, at intervals of approximately 60° in the circumferential direction of the outer circumferential surface 71a. As shown in FIG. 16, the inner side of the gear housing 14 has a circular inner circumferential surface 14d and a plurality of grooves 14e recessed radially outward from the inner circumferential surface 14d when viewed from the left or right side. The inner circumferential surface 14d of the gear housing 14 faces the outer circumferential surface 71a of the outer ring 71 with a slight space in the radial direction. The plurality of projections 71b of the outer ring 71 can be inserted into the plurality of grooves 14e of the gear housing 14. As a result, the outer ring 71 is prevented from rotating around the intermediate axis J2 and held in the gear housing 14.

As shown in FIG. 15, a spline groove 72b is formed at the radially central portion of the inner ring 72. A spline shaft 43c that engages the spline groove 72b is formed on the outer circumference of the intermediate shaft 43. By engaging the spline groove 72b with the spline shaft 43c, the inner ring 72 rotates integrally with the intermediate shaft 43 around its axis (J2).

As shown in FIG. 15, a plurality of wedge grooves 73 are formed on the outer circumferential surface 72a of the inner ring 72. In this embodiment, six wedge grooves 73 are formed at intervals of approximately 60° in the circumferential direction. A cylindrical wedge member 74 is inserted into each wedge groove 73. The length of the wedge member 74 in the axial direction (left-right direction) is approximately the same as the width of the outer ring 71 and/or inner ring 72 in the axial direction. The wedge member 74 each is held in place by the left and right washers 70a and 70b such that it cannot slip out of the wedge groove 73.

As shown in FIG. 16, the wedge grooves 73 are recessed radially inward from the outer circumferential surface 72a of the inner ring 72 and extend circumferentially longer than the groove depth. Each wedge groove 73 is formed in substantially the same shape. The groove depth of the wedge grooves 73 gradually becomes shallower in the forward rotation direction R1. The rear portion of the wedge groove 73 in the forward rotation direction R1 is a deep groove portion 73a in which the groove depth is greater than the diameter of the wedge member 74. The front portion of the wedge groove 73 in the forward rotation direction R1 is a shallow groove portion 73b in which the groove depth is smaller than the diameter of the wedge member 74.

As shown in FIG. 16, when the inner ring 72 rotates in the forward rotation direction R1, each wedge member 74 moves toward the deep groove portion 73a within the wedge groove 73. Therefore, a space is formed between each wedge member 74 and the inner circumferential surface 71c of the outer ring 71 and/or between each wedge member 74 and the bottom of the deep groove 73a. Because of this configuration, when the inner ring 72 rotates in the forward rotation direction R1, the lifter 60 rotates in the forward rotation direction R1. Accordingly, the intermediate shaft 43, the driven bevel gear 44, and the driving spur gear 45 rotate together with the inner ring 72 in the forward rotation direction R1 (refer to FIG. 5). When the inner ring 72 rotates in the forward rotation direction R1, the lifter 60 rotates in the counterclockwise direction in FIG. 7.

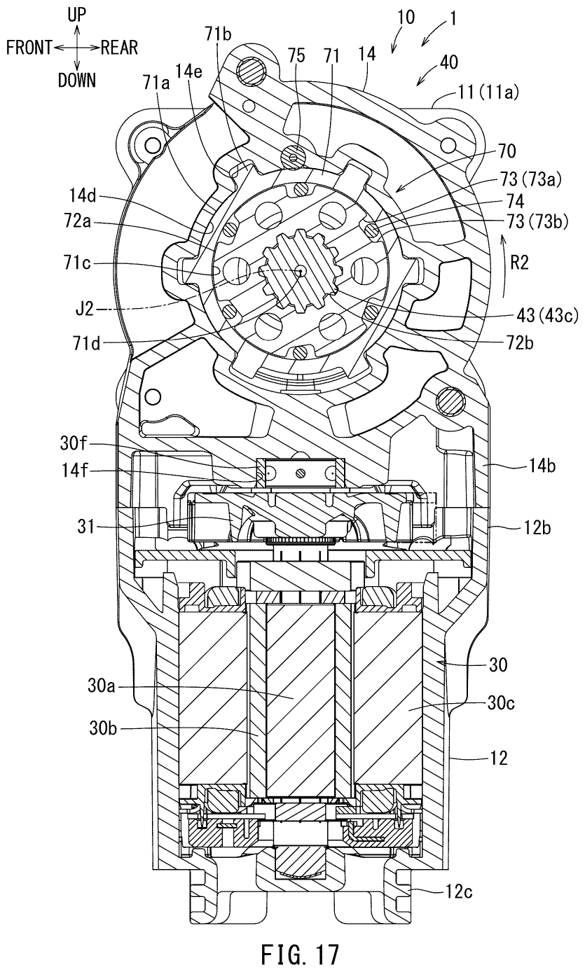

As shown in FIG. 17, when the inner ring 72 is urged to rotate in the reverse rotation direction R2, each wedge member 74 moves within the wedge groove 73 toward the shallow groove portion 73b. As a result, each wedge member 74 is clamped (wedged) between the inner circumferential surface 71c of the outer ring 71 and the shallow groove portion 73b of the wedge groove 73. For example, when there are three or more wedge members 74 clamped between the inner circumferential surface 71c of the outer ring 71 and the wedge grooves 73, rotation of the inner ring 72 is restricted in the reverse rotation direction R2. More specifically, rotation of the inner ring 72 in the reverse rotation direction R2 is restricted when the intermediate axis J2 is located inside a triangle formed by the clamped three wedge members 74 in left and right side views. When the inner ring 72 is urged to rotate in the reverse rotation direction R2, the lifter 60 is caused to rotate in the clockwise direction in FIG. 7.

As shown in FIG. 16, an elastic member 75, such as a cylindrical rubber member, is placed between the upper portion of the outer circumferential surface 71a of the outer ring 71 and the inner circumferential surface 14d of the gear housing 14. The function of the elastic member 75 is to bias the outer ring 71 downward. This downward bias utilizes the dimensional tolerance for assembly between the outer circumferential surface 71a of the outer ring 71 and the inner circumferential surface 14d of the gear housing 14 to slightly displace the outer ring 71 downward. As a result of this displacement, the center 71d of the inner circumferential surface 71c of the outer ring 71, which serves as the center of rotation of the outer ring 71, is located slightly below the intermediate axis J2, which is the center of rotation of the inner ring 72. This configuration causes the radial distance between the bottom of each wedge groove 73 and the inner circumferential surface 71c of the outer ring 71 to vary depending on the position of each wedge groove 73. Specifically, the distance is slightly shorter in the wedge grooves 73 located above the intermediate axis J2. The distance is slightly longer in the wedge grooves 73 located below the intermediate axis J2.

The inner ring 72 normally rotates in the forward rotation direction R1. Therefore, each of the wedge member 74 is located generally in the deep groove portion 73a. A lubricant such as grease is filled in places such as those where gears engage each other in the gear housing 14. For example, grease may inadvertently enter the wedge groove 73 and solidify. In such a case, the wedge member 74 located in the deep groove portion 73a may not be able to pass over the solidified grease, etc., and may be prevented from moving to the shallow groove portion 73b when the inner ring 72 rotates in the reverse rotation direction R2. Even in such a case, by biasing the outer ring 71 with the elastic member 75, the wedge groove 73, which has a short radial distance between the bottom of the groove and the inner circumferential surface 71c of the outer ring 71, always exists. Accordingly, even if the wedge member 74 is prevented from moving due to grease, etc., the wedge member 74 can be clamped (wedged) between the bottom of the wedge groove 73 and the inner circumferential surface 71c of the outer ring 71. Thus, the wedge members 74 can more reliably restrict the rotation of the inner ring 72 in the reverse rotation direction R2.

There is a time lag between the moment the inner ring 72 starts rotating in the reverse rotation direction R2 and the point at which the stopper 70 brings it to a stop. Therefore, the inner ring 72 continue to rotate in the reverse rotation direction R2 from the moment it starts until it comes to a stop. A rotation angle of the inner ring 72 before it comes to a stop is not constant, but varies within a certain range. As shown in FIG. 14, the stopper 70 is positioned on the upstream side of the downstream speed reduction section 41b. For example, if the reduction ratio of the downstream speed reduction section 41b is 1/10, the rotation angle of the lifter shaft 61 from the start of reverse rotation to its stop is 1/10 of the rotation angle of the intermediate shaft 43, which is integrated with the inner ring 72. The rotation angle of the lifter shaft 61 is proportional to the amount of movement of the driver 24 in the front-rear direction. Accordingly, placing the stopper 70 on the upstream side of the downstream speed reduction section 41b allows for reduction in the amount of the front-rear movement of the driver 24 during reverse operation of the lifter 60, and also helps minimize movement error.

As shown in FIG. 5, the stopper 70 is located on the downstream side of the upstream speed reduction section 41a. Considering only the reduction ratio, it is preferable to located the stopper 70 on the upstream side of the driving bevel gear 42. However, when the stopper 70 is located between the driving bevel gear 42 and the bearing 30e, the driving bevel gear 42 is separated from the bearing 30e. Therefore, it is difficult to effectively suppress the wobble of the driving bevel gear 42 supported by the bearing 30e. Thus, it is difficult to located the stopper 70 on the upstream side of the driving bevel gear 42. The driven bevel gear 44 is provided with a diameter equal to or greater than a specified value in order to achieve the required reduction ratio relative to the driving bevel gear 42. Therefore, it is easy to secure a space for positioning the stopper 70 in the vicinity of the driven bevel gear 44. Accordingly, in the present embodiment, the stopper 70 is positioned on the downstream side of the upstream speed reduction section 41a and on the upstream side of the downstream speed reduction section 41b.

### <Buffering Mechanism 50>

As shown in FIG. 18, a buffering mechanism 50 has a driven spur gear 51 as an upstream rotating member and a driving ring 52 as a downstream rotating member. A disc-shaped upstream disc portion 51a is disposed on the right side of the driven spur gear 51. The upstream disc portion 51a extends in a flat plate shape perpendicular to the left-right direction. An outer circumferential surface of the driven spur gear 51 extends in a cylindrical shape to the left from the upstream disc portion 51a. External teeth 51g that engage the driving spur gear 45 (refer to FIG. 14) are formed on the outer circumferential surface of the driven spur gear 51. A recess 51b opening toward the left side is formed on the inner circumferential surface of the outer circumferential surface of the driven spur gear 51. A circular hole 51f is formed at the radial center of the driven spur gear 51, penetrating the upstream disc portion 51a in the left-right direction. The lifter shaft 61 is inserted into the hole 51f.

As shown in FIG. 18, a plurality of upstream protrusions 51c project to the left from the upstream disc portion 51a and are formed within the recess 51b of the follower spur gear 51 (also referred to as the driven spur gear). In this exemplary embodiment, three upstream protrusions 51c are formed, arranged at intervals of approximately 120° in the circumferential direction. When viewed from the left or right side, the upstream protrusions 51c are fan-shaped. The left end face of the upstream protrusion 51c is a flat surface, parallel to the upstream disc portion 51a. The left end face of the upstream protrusion 51c is located to the right of the left end of the entire driven spur gear 51. More specifically, its position to the right corresponds to a length equal to the thickness of a downstream disc portion 52a. When the driven spur gear 51, the buffering member 53, and the driving ring 52 are assembled, at least a part of the downstream spur gear 52a is housed in the recess 51b of the follower spur gear 51. More preferably, the entirety of the downstream spur gear 52a is housed within the recess 51b.

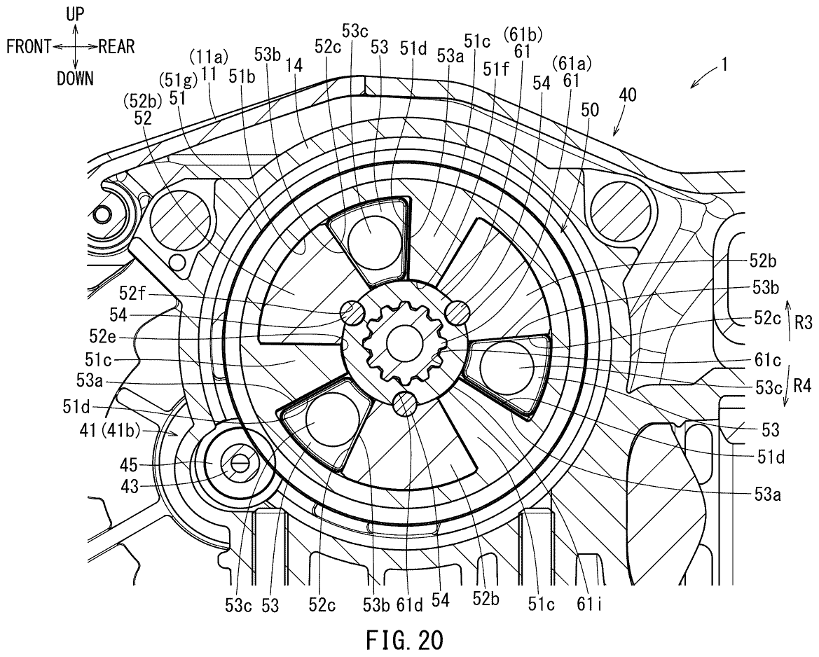

As shown in FIG. 18, the upstream protrusion 51c has an upstream side surface 51d in front of the forward rotation direction R3 (refer to FIG. 20) and an upstream inclined side surface 51e behind the forward rotation direction R3. The upstream side surface 51d and the upstream inclined side surface 51e extend in a flat surface in the radial direction between the outer circumferential surface of the follower spur gear 51 and the hole 51f. The upstream side surface 51d is perpendicular to the upstream disc portion 51a. The upstream inclined side surface 51e is inclined toward the rear of the forward rotation direction R3 as it approaches the upstream disc portion 51a from the left to the right. The upstream inclined side surface 51e is inclined at an inclination angle of, for example, 30° to 60° with respect to the upstream disc portion 51a.

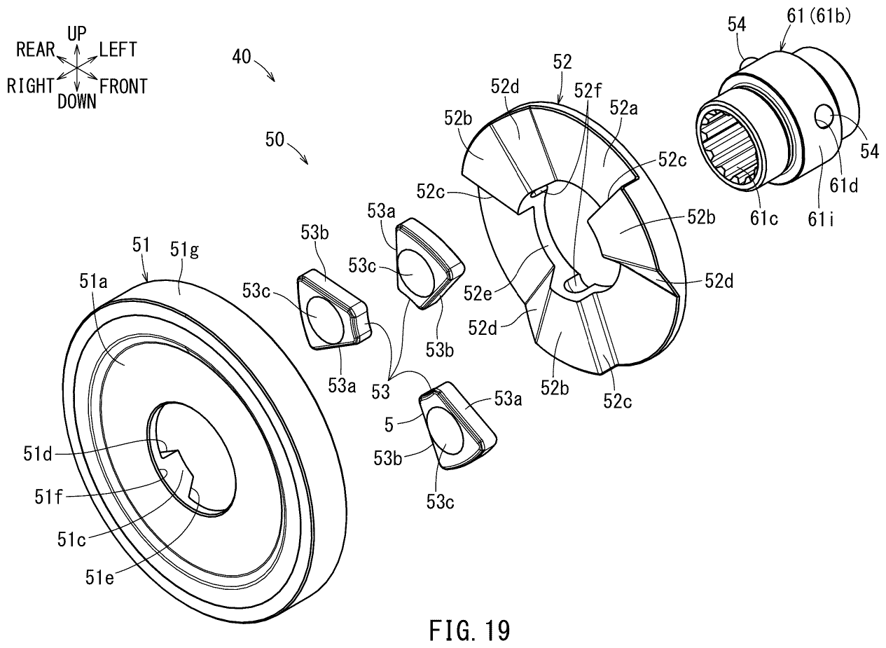

As shown in FIGS. 18 and 19, the left side of the driving ring 52 is a disc-shaped downstream disc portion 52a. The downstream disc portion 52a extends in a flat plate shape perpendicular to the left-right direction. A circular hole 52e is formed in the radial center of the driving ring 52, penetrating the downstream disc portion 52a in the left-right direction. The lifter shaft 61 is inserted into the hole 52e. The driving ring 52 has a plurality of downstream protrusions 52b projecting to the right from the downstream disc portion 52a. In this embodiment, three downstream protrusions 52b are formed at intervals of approximately 120° in the circumferential direction. The downstream protrusions 52b are fan-shaped when viewed from the left or right side. The right end surface of the downstream protrusions 52b is flat and parallel to the downstream disc portion 52a.

As shown in FIG. 19, each of the downstream protrusions 52b has a downstream inclined side surface 52d in front of the forward rotation direction R3 (refer to FIG. 20) and a downstream side surface 52c behind the forward rotation direction R3. Both the downstream side surface 52c and the downstream inclined side surface 52d extend as a flat surface in the radial direction. This extension runs from the central hole 52e of the driving ring 52 out to its outer circumferential edge. The downstream side surface 52c is perpendicular to the downstream disc portion 52a. The downstream inclined side surface 52d is inclined toward the rear of the forward rotation direction R3. This inclination approaches the downstream disc portion 52a as it moves from the right to the left. The downstream inclined side surface 52d is inclined toward the downstream disc portion 52a at an angle that is approximately the same as the inclination angle of the upstream inclined side surface 51e.

As shown in FIGS. 18 and 19, the driving ring 52 has a plurality of ball grooves 52f that communicate with the hole 52e. The plurality of ball grooves 52f are formed on each of the inner peripheral edge of the downstream protrusions 52b. Specifically, three ball grooves 52f are formed in total. The ball grooves 52f extend from the left side of the downstream disc portion 52a toward the right. Each ball groove 52f has a tubular surface on the opening side (left side) and a spherical surface on the bottom side (right side). The groove depth of each ball groove 52f is approximately constant in the left-right direction.

As shown in FIG. 18, three buffering members 53 are provided in the buffering mechanism 50. The buffering members 53 are made of, for example, a highly elastic rubber. The buffering members 53 are formed in a substantially same shape. The buffering members 53 are fan-shaped when viewed from the left or right side. An outer circumferential surface of the buffering members 53 faces the inner circumferential surface of the recess 51b of the follower spur gear 51 in the radial direction. The inner circumferential surface of the buffering members 53 faces the outer circumferential surface 61i of the lifter shaft 61 in the radial direction. The buffering members 53 have a substantially constant thickness in the left-right direction, except at the protrusions 53c described later.

As shown in FIG. 20, each of the buffering member 53 has a second side surface 53b in front of the forward rotation direction R3 and a first side surface 53a behind the forward rotation direction R3. The first side surface 53a and the second side surface 53b extend in a flat surface in the left-right direction. The first side surface 53a and the second side surface 53b are perpendicular to the upstream disc portion 51a and/or the downstream disc portion 52a. The first side surface 53a and the second side surface 53b are based on the positional relationship when the buffering member 53 is assembled between the follower spur gear 51 and the driving ring 52. Since the buffering member 53 has a symmetrical shape before assembly, it can be properly installed between the driven spur gear 51 and the driving ring 52 even if the illustrated first side surface 53a and the second side surface 53b are reversed.

As shown in FIGS. 18 and 19, a protrusion 53c is provided at the center of both left and right side surfaces of the buffering member 53. The protrusion 53c extends spherically outward from the buffering member 53 to both the left and right sides. The protrusion 53c is circular in shape when viewed from the left or right side. The right protrusion 53c elastically contacts the left side surface of the upstream disc portion 51a. The left protrusion 53c elastically contacts the right side of the downstream disc portion 52a. As shown in FIG. 6, the buffer member 53 is clamped between the upstream disc portion 51a and the downstream disc portion 52a in the left-right direction. The buffer member 53 is housed within the width of the follower spur gear 51 in the left-right direction.

As shown in FIG. 20, the buffering member 53 is housed between the upstream protrusion 51c and the downstream protrusion 52b in the circumferential direction. The first side surface 53a of the buffering member 53 elastically contacts the upstream side surface 51d of the driven spur gear 51 in the circumferential direction. The second side surface 53b of the buffering member 53 elastically contacts the downstream side surface 52c of the driving ring 52 in the circumferential direction. As shown in FIG. 18, the upstream inclined side surface 51e of the driven spur gear 51 and the downstream inclined side surface 52d of the driving ring 52 face each other when assembled.

By providing the upstream inclined side surface 51e of the driven spur gear 51 and the downstream inclined side surface 52d of the driving ring 52, it is possible to prevent the buffering member 53 from being housed in an incorrect position. For example, even if the buffering member 53 is urged to the space between the upstream inclined side surface 51e and the downstream inclined side surface 52d, the buffering member 53 cannot be housed there. This is because the upstream inclined side surface 51e and the downstream inclined side surface 52d are inclined with respect to each outer surface of the buffering member 53. Consequently, the buffering member 53 cannot be assembled correctly in that orientation. During the assembly process, the follower spur gear 51 is rotated in the forward rotation direction R3 relative to the driving ring 52. This brings the upstream inclined side surface 51e closer to the downstream inclined side surface 52d in the circumferential direction. As a result, the upstream side surface 51d presses the first side surface 53a of the buffering member 53 in the circumferential direction, moving the buffering member 53 to its normal position for correct assembly.

As shown in FIG. 6, the lifter shaft 61 is arranged as an integral shaft member by connecting the left shaft main body 61a and the right shaft sleeve 61b. A wheel 62 connects to the shaft main body 61a. The buffering mechanism 50 connects to the shaft sleeve 61b. A spline groove 61c, which engages a spline shaft of the shaft main body 61a, is formed at the radial center of the shaft sleeve 61b.

As shown in FIGS. 19 and 20, three ball holes 61d are formed on an outer circumferential surface 61i of the shaft sleeve 61b at intervals of approximately 120° in the circumferential direction. The ball holes 61d are recessed radially inward in a hemispherical shape. A metal balls 54 is inserted into each of the ball hole 61d. The hemispherical portions of the balls 54 projecting radially outward from the ball holes 61d are inserted into the ball grooves 52f of the driving ring 52. Because of this configuration, the driving ring 52 integrally connects to the shaft sleeve 61b via the balls 54. The driving ring 52 is integrally rotatable around the lifter axis J3 together with the lifter shaft 61.

As shown in FIG. 20, the driven spur gear 51 is rotated in the forward rotation direction R3 around the lifter axis J3 by receiving power transmitted from the driving spur gear 45. At this time, the upstream side surface 51d of the driven spur gear 51 elastically presses the first side surface 53a of the buffering member 53 in the forward rotation direction R3. Furthermore, the second side surface 53b of the buffering member 53 elastically presses the downstream side surface 52c of the driving ring 52 in the forward rotation direction R3. As a result, the driving ring 52 rotates in the forward rotation direction R3 around the lifter axis J3 together with the lifter shaft 61. Accordingly, the lifter 60 rotates counterclockwise in the forward rotation direction, as illustrated in FIG. 7.

As illustrated in FIG. 20, the driving ring 52 may be caused to rotate in the reverse rotation direction R4 together with the lifter shaft 61. In more detail, the lifter shaft 61 may rotate in the reverse direction when the impact from the driving operation of the driver 24 or its rearward movement is transmitted to the lifter 60 (see FIG. 7). In addition, for example, when the lifter 60 and the driver 24 are misaligned and the engaging pin 63 of the lifter 60 comes into contact with the rack tooth 24a of the driver 24 moving forward, the lifter shaft 61 may rotate in the reverse direction. At this time, the downstream side surface 52c of the driving ring 52 elastically pushes the second side surface 53b of the buffering member 53 in the reverse rotation direction R4. Furthermore, the first side surface 53a of the buffering member 53 elastically pushes the upstream side surface 51d of the driven spur gear 51 in the reverse rotation direction R4. Accordingly, the impact applied to the driving ring 52 is reduced by the buffering member 53, thereby suppressing the impact from being transmitted to the driven spur gear 51 and upstream components. Since the driven spur gear 51 is the final-stage speed reduction gear of the speed reduction mechanism 41, the buffering mechanism 50 can suppress the transmission of impact from the lifter 60 to all the reduction gears in the speed reduction mechanism 41.

### <Magazine 80>

As shown in FIG. 1, the magazine 80 formed in a substantially rectangular box shape is arranged below the driving nose 2. The magazine 80 extends straight downward from the driver guide 16. The magazine 80 connects to the driver guide 16 at the upper portion 80a. Also, the magazine 80 connects to the lower housing 11d at the lower portion 80b. The magazine 80 is mainly made of metal and has high rigidity. Due to this configuration, the mechanism unit 13 (see FIG. 7) and the lower housing 11d are connected in the up-down direction not only via the motor housing 12 but also via the magazine 80.

As shown in FIG. 2, a plurality of driving members N are loaded in the magazine 80 in parallel in the up-down direction. The driving members N are loaded in the magazine 80 in a posture in which the head Na is located at the rear end and a pair of legs Nb extend forward from the left and right ends of the head Na. The magazine 80 is provided with a pusher 81 for supplying the driving members N to the driving passage 2a located above. The pusher surface 81a of the upper end of the pusher 81 biases the plural driving members N upward. The pusher 81 has a spiral spring 81c as a biasing member that biases it upward.

As shown in FIG. 3, the magazine 80 is provided with a front rail 80c and a rear rail 80c that extend straight in the up-down direction. The upper portion of the rear rail 80c includes a bulging section 80d that projects in the lateral (left-right) direction. The head Na of the driving member N is held so as not to fall out, for example, rearwardly from the magazine 80 by being inserted into the bulging section 80d. As shown in FIG. 10, the pusher 81 has rail engagement portions 81b that engage with the rails 80c. The pusher 81 is slidable in the up-down direction along the rails 80c.

As shown in FIG. 1, a lock release lever 81d is arranged at the front portion of the pusher 81. The user can push the lock release lever 81d with a finger. A box-shaped recess 81f is formed at the lower portion of the pusher 81. The recess 81f opens toward the left and is surrounded by walls on the front, rear, top, bottom, and right sides. The user can press the lock release lever 81d with one finger while hooking another finger into the recess 81f. Accordingly, the lock release lever 81d can be pressed and the pusher 81 can be slid up-down direction with one hand.

As shown in FIGS. 1 and 8, a pair of claws 81e are provided integrally with the lock release lever 81d. The claws 81e project forward in an L shape. The claws 81e and the lock release lever 81d are biased forward by a biasing member (not shown). When the lock release lever 81d is pushed rearward, the claws 81e also move rearward. A claw engagement portion 80e is provided at the front end of the lower portion 80b of the magazine 80. The claw engagement portion 80e is pin-shaped extending in the left-right direction and releasably engages the claws 81e. The claws 81e engages the claw engagement portion 80e, thereby holding the pusher 81 at the lowest position.

As shown in FIG. 1, a recess 11h is formed in the left portion of the lower housing 11d. The height of the upper end of the recess 11h is lower than the right portion of the lower housing 11d that connects to the motor housing 12. The recess 11h is disposed rearward of the magazine 80. As shown in FIG. 3, the upper end surface of the recess 11h is substantially horizontal and lower than the pusher surface 81a of the pusher 81 when the pusher 81 is at its lowest position. This configuration creates a space for loading the driving members N into the magazine 80 at the rear of the magazine 80 and above the recess 11h. While the pusher 81 is being held at its lowest position, a plurality of driving members N can be loaded from the rear end of the magazine 80 toward the front. After the driving members N are placed on the pusher surface 81a, the engagement between the claw 81e and the claw engagement portion 80e is released (see FIG. 8). As a result, the driving members are loaded into the magazine 80 by being pushed upward by the pusher 81.

As shown in FIG. 3, a release lever 80f is on the left side of the lower portion 80b of the magazine 80. When the user moves the magazine 80 forward and downward while pressing the release lever 80f, the lower portion 80b of the magazine 80 can be removed from the lower housing 11d. When attaching the lower portion 80b of the magazine 80 to the lower housing 11d, the magazine 80 can be automatically attached by bringing the lower portion 80b of the magazine 80 toward the lower housing 11d in a rearward and upward direction without pressing the release lever 80f.

Next, a series of driving operations of the driving tool 1 will be described with reference to FIGS. 1 to 20. In the standby position, the driver 24 is stopped slightly before the top dead center (see FIG. 8). When the driver 24 is in the standby position, the bottom surface of the foremost rack tooth 24a engages the last engaging pin 63b. The contact arm 3 moves rearward when pressed against the workpiece W. The adjuster 6 moves rearward together with the contact arm 3 and presses the switch 6c. The switch 6c transmits an on signal to the controller 35. The controller 35 activates the electric motor 30 when it receives the on signal from the switch 6c and the trigger 5 is pressed rearward. When the electric motor 30 is activated, the wheel 62 of the lifter 60 rotates. The last engaging pin 63b moves the foremost rack tooth 24a in the rearward direction. Due to this movement, the driver 24 moves rearward from the standby position to the top dead center.

When the driver 24 is stopped at the standby position, the tip end 24b of the driver 24 overlaps the head Na of the driving member N, which is closest to the driving passage 2a, in the front-rear direction. Therefore, no driving member N is loaded in the driving passage 2a. When the tip end 24b of the driver 24 moves rearward relative to the head Na of the driving member N, the uppermost driving member N is loaded into the driving passage 2a. When the driver 24 moves to the top dead center immediately before driving of the driving member N, the last engaging pin 63b moves upward to disengage from the bottom surface of the foremost rack tooth 24a. Then, the driver 24 moves forward due to the gas pressure in the accumulation chamber 22 that has acted on the piston 23. The tip end 24b of the driver 24 strikes (drives) the driving member N in the driving passage 2a in the forward direction. The driving member N, driven by the driver 24, is ejected from the ejection port 2b into the workpiece W.

The wheel 62 continues to rotate while the driver 24 is moving forward and after it has reached the bottom dead center. After the driver 24 has reached the bottom dead center, the first engaging pin 63a engages the bottom surface of the rearmost rack tooth 24a when the wheel 62 rotates to a predetermined rotation angle. Due to this movement, a return operation is initiated to move the driver 24 to its rear standby position. When the last engaging pin 63b engages the bottom surface of the foremost rack tooth 24a, the driver 24 returns to the standby position. For example, by appropriately measuring the time from the start of the electric motor 30 or by appropriately measuring the rotational position of the wheel 62, the electric motor 30 is stopped when the piston 23 reaches the standby position. As a result, the driver 24 is held at the standby position, thereby completing the series of driving operations.

According to one feature of the present disclosure, the driving tool 1 has the driving mechanism 20 and the lifter 60 as shown in FIGS. 6, 7, 18, and 20. The driving mechanism 20 biases the driver 24 forward. The lifter 60 moves the driver 24 rearward. The driving tool 1 has the driven spur gear (serving as the upstream rotating member) 51, the driving ring (serving as the downstream rotating member) 52, and the buffering member 53. The driven spur gear 51 is positioned in the power transmission path that transfers power from the electric motor 30 to the lifter shaft 60 and rotates around its axis. The driving ring 52 rotates coaxially with the driven spur gear 51, located downstream of the driven spur gear 51. The buffering member 53 is placed between the driven spur gear 51 and the driving ring 52. The rotational power of the driven spur gear 51 is transmitted to the driving ring 52 while being buffered through the buffering member 53.

Therefore, when the driven spur gear 51 rotates forward, the buffering member 53 transmits the rotational power of the driven spur gear 51 to the driving ring 52 while functioning to buffer the rotational power of the driven spur gear 51 before transmitting it to the driving ring 52. Therefore, the rotational power of the driven spur gear 51 can be reliably transmitted to the downstream rotating member. Also, when an impact is transmitted from the lifter 60 to the driving ring 52, the impact is mitigated by the buffering member 53 before being transmitted to the driven spur gear 51. The buffering member 53 is always interposed in the path where the impact is transmitted from the driving ring 52 to the driven spur gear 51. Accordingly, this configuration effectively suppresses the transmission of the impact from the lifter 60 to the electric motor 30 and the power transmission path located upstream.

Moreover, the driven spur gear 51 and the driving ring 52 can be applied to various components that mutually rotate around the same axis. For example, the driving ring 52 can be made integral with the lifter shaft 61 or with a rotating component upstream of the lifter shaft 61. For example, the upstream component can be a gear in a reduction gear, such as a bevel gear, spur gear, or helical gear, or a component that can rotate together with these gears. Accordingly, bevel gears, spur gears, helical gears, etc. with the above configuration can be incorporated in the power transmission path between the electric motor 30 and the lifter 60.

As shown in FIGS. 18 to 20, the buffering member 53 has a first side surface 53a and a second side surface 53b. The first side surface 53a is perpendicular to and elastically contacts the upstream side 51d of the driven spur gear 51 in the rotation direction. The second side surface 53b is perpendicular to and elastically contacts the downstream side surface 52c of the driving ring 52 in the forward rotation direction relative to the first side surface 53a.

Therefore, during a forward rotation of the driven spur gear 51 (upstream rotating member), the upstream side surface 51d pushes the first side surface 53a of the buffering member 53 in the forward rotation direction. Concurrently, the second side surface 53b of the buffering member 53 pushes the downstream side surface 52c of the driving ring 52 (downstream rotating member) in the forward rotation direction. This arrangement suppresses the conversion of the rotational power of the driven spur gear 51 into a force that pushes the buffering member 53 and the driving ring 52 in the axial direction. Consequently, the rotational power of the driven spur gear 51 is efficiently transmitted to the driving ring 52. When an impact is transmitted from the lifter 60 to the driving ring 52, the downstream side surface 52c of the driving ring 52 pushes the second side surface 53b of the buffering member 53 in the reverse rotation direction. Subsequently, the first side surface 53a of the buffering member 53 pushes the upstream side surface 51d in the reverse rotation direction. This prevents the buffering member 53 and the driven spur gear 51 from being pushed in the axial direction. As a result, the impact transmitted from the driving ring 52 to the driven spur gear 51 is suppressed by the buffering member 53, and the transmission of impact to the driven spur gear 51 in the axial direction is also suppressed.

As shown in FIGS. 18 and 19, the driven spur gear 51 has the upstream inclined side surface 51e that is inclined with respect to the rotation direction. The driving ring 52 has the downstream inclined side surface 52d, which faces the upstream inclined side surface 51e and is inclined in the rotation direction.

Therefore, it is possible to prevent the buffering member 53 from being housed between the upstream inclined side surface 51e and the downstream inclined side surface 52d during assembly. Even if an attempt is made to house the buffering member 53 between the upstream inclined side surface 51e and the downstream inclined side surface 52d, a space between the upstream inclined side surface 51e and the downstream inclined side surface 52d does not match the shape of the buffering member 53. Consequently, the buffering member 53 cannot be housed between the upstream inclined side surface 51e and the downstream inclined side surface 52d to be assembled properly. This configuration makes it easy to check during the assembly work whether the buffering member 53 is housed at the normal position between the upstream side surface 51d and the downstream side surface 52c. Additionally, during the assembly work, the driven spur gear 51 and the driving ring 52 are rotated relative to each other such that the upstream inclined side surface 51e and the downstream inclined side surface 52d are positioned circumferentially closer to each other. This allows the buffering member 53 to be assembled in such a way that it reliably comes into contact with both the upstream side surface 51d and downstream side surface 52c.

As shown in FIGS. 6, 14, and 20, the driving ring 52 rotates integrally with the lifter shaft 61 of the lifter 60. The driven spur gear 51 rotates integrally with the final driven gear at the most downstream position in the power transmission path of the power transmission mechanism 40. Therefore, the buffering member 53 is located downstream of the final driven gear (driven spur gear 51), which is at the most downstream position in the power transmission path. This prevents the impact of the lifter 60 from being transmitted to all the gears in the power transmission path.

As shown in FIGS. 18 to 20, the ball 54 is interposed between the hole (inner circumferential surface) 52e of the driving ring 52 and the outer circumferential surface 61i of the lifter shaft 61. The driving ring 52 and the lifter shaft 61 are coupled together via the ball 54, and are prevented from rotating relative to each other. Therefore, a simple connection structure using the ball 54 enables regulation of the relative rotation between the driving ring 52 and the lifter shaft 61, while facilitating assembly.

As shown in FIGS. 18 to 20, the driven spur gear 51 has the external teeth 51g and the recess 51b. The external teeth 51g are formed on the outer circumferential surface of the driven spur gear 51. The recess 51b is formed on a surface facing the driving ring 52. At least a part of the buffering members 53 is housed in the recess 51b. Therefore, by housing the buffering member 53 in the recess 51b of the driven spur gear 51, the buffering mechanism 50, which comprises the driven spur gear 51, the buffering member 53 and the driving ring 52, can be installed in a compact manner.

As shown in FIG. 6, the buffering member 53 is housed within the axial width of the driven spur gear 51. Therefore, the buffering mechanism 50, which assembles the driven spur gear 51, the buffering member 53 and the driving ring 52, can be made compact in the axial direction.

As shown in FIGS. 6, 18, and 19, the driven spur gear 51 has the upstream disc portion 51a that covers the buffering member 53 in the axial direction. The driving ring 52 has the downstream disc portion 52a the covers the buffering member 53 from the opposite side of the upstream disc portion 51a. Therefore, by clamping the buffering member 53 between the upstream disc portion 51a and the downstream disc portion 52a during assembly, the buffering member 53 can be properly positioned in the axial direction.

As shown in FIGS. 6, and 18 to 20, the buffering member 53 has the protrusion 53c projecting in the axial direction. The protrusion 53c elastically contacts the upstream disc portion 51a or the downstream disc portion 52a. Therefore, the protrusions 53c of the buffering member 53 biases the upstream disc portion 51a or the downstream disc portion 52a in the axial direction. A small space is provided between the driven spur gear 51 or the driving ring 52 and the mechanism housing in the axial direction such that the driven spur gear 51 and the driving ring 52 can rotate. The axial biasing force of the protrusions 53c can suppress the axial play of the driven spur gear 51 or the driving ring 52.

As shown in FIG. 7, the driving mechanism 20 has the piston 23 and the accumulation chamber 22. The piston 23 is movable together with the driver 24. The accumulation chamber 22 is pressurized by the rearward movement of the piston 23. The lifter 60 may receive an impact when the driver 24 moves rearward or the driving operation of the driver 24 is performed. In addition, if a misalignment occurs between the lifter 60 and the driver 24, there is a risk that the lifter 60 may come into contact with the driver 24 as it moves forward, causing an impact. In the so-called gas spring type driving tool 1, the present disclosure prevents the impact on the lifter 60 side from being transmitted to the upstream motor 30 and the power transmission path.

As shown in FIGS. 5, 7, and 14, the driving tool 1 has the driving mechanism 20, the lifter 60, and the speed reduction mechanism 41, as described above. The driving mechanism 20 biases the driver 24 forward. The lifter 60 moves the driver 24 rearward. The reduction mechanism 41 reduces the output of the electric motor 30 through multiple stages and transmits it to the lifter 60. One of the multiple stages of the speed reduction mechanism 41 has the drive bevel gear 42 and the driven bevel gear 44 that engage with each other. The stopper 70 is positioned downstream of the driven bevel gear 44 to suppress the reverse rotation of the lifter 60.

Therefore, while the drive bevel gear 42 and the driven bevel gear 44 are arranged in the power transmission path between the electric motor 30 and the lifter 60, the stopper 70 can be positioned downstream of the driven bevel gear 44. Accordingly, the stopper 70 is positioned downstream of the drive bevel gear 42 and the driven bevel gear 44, after the output of the electric motor 30 has been reduced. This makes it possible to suppress heat generation in the stopper 70 during power transmission, while preventing reverse rotation of the lifter 60 from being transmitted upstream of the driven bevel gear 44. By restricting the reverse rotation of the driven bevel gear 44, the reverse rotation of the lifter 60 located downstream can also be restricted.

As shown in FIGS. 5 and 14, the speed reduction mechanism 41 includes the downstream speed reduction section 41b. The downstream speed reduction section 41b is positioned between the intermediate shaft 43, which is driven by the driven bevel gear 44, and the lifter shaft 61 of the lifter 60 to reduce rotation speed. Therefore, a reduction stage is interposed between the intermediate shaft 43 and the lifter shaft 61. Accordingly, the rotation angle of the lifter shaft 61 during reverse rotation, from initiation to cessation, can be made smaller than that of the intermediate shaft 43 and the stopper 70. Therefore, the front-rear displacement of the driver 24 during reverse rotation of the lifter 60 can be minimized. This makes it possible to reduce the positional error of the driver 24, especially the error in its standby position.

As shown in FIGS. 15 to 17, the stopper 70 restricts the rotation of the intermediate shaft (rotating member) 43, which rotates integrally with driven bevel gear 44. Therefore, the stopper 70 directly restricts the rotation of the intermediate shaft 43, thereby restricting the reverse rotation of lifter shaft 60 more reliably.

As shown in FIGS. 15 to 17, the stopper 70 has the inner ring 72, the outer ring 71, the wedge grooves 73, and the wedge members 74. The inner ring 72 is coupled to the outer circumference of the intermediate shaft 43. The outer ring 71 surrounds the inner ring 72 from the outside and is retained in the tool main body 10. The wedge grooves 73 are recessed on either the outer circumferential surface 72a of the inner ring 72 or the inner circumferential surface 71c of the outer ring 71. A The wedge member 74 is movably disposed within the wedge groove 73. The wedge member 74 permits the forward rotation of the inner ring 72. When the inner ring 72 rotates in the reverse direction, the wedge member 74 is clamped between the inner ring 72 and the outer ring 71, thereby restricting reverse rotation of the inner ring 72. Accordingly, the wedge member 74 allows the forward rotation of the inner ring 72 and restricts its reverse rotation by moving within the wedge groove 73. This allows the stopper 70 to be arranged without a biasing spring or the like for the wedge member 74. Therefore, the number of parts for the stopper 70 can be reduced, which makes the stopper 70 compact and helps improve the ease of its assembly.

As shown in FIGS. 16 and 17, the elastic member 75 is arranged which biases the outer ring 71 in a manner such that the center 71d of the outer ring 71 is shifted from the intermediate axis J2, which is the center of rotation of the inner ring 72. Accordingly, a plurality of wedge grooves 73 and the wedge members 74 are provided in the stopper 70, and the center 71d of the outer ring 71 is displaced from the intermediate axis of rotation J2. This allows the radial distance from the groove bottom of any of the plurality of wedge groove 73 to the outer circumferential surface 72a of the opposing inner ring 72 or the inner circumferential surface 71c of the outer ring 71 to be reduced. Therefore, when the inner ring 72 rotates in the reverse direction, the wedge member 74 can be reliably engaged (wedged) between the inner ring 72 and the outer ring 71. As a result, the inner ring 72 rotating in the reverse rotation can be reliably stopped.

As shown in FIGS. 5 and 14, the downstream speed reduction section 41b has the drive spur gear (downstream drive gear) 45 that rotates integrally with the intermediate shaft 43. The drive bevel gear 42 is positioned between the drive spur gear 45 and the driven bevel gear 44 in the axial direction of the intermediate shaft 43. Therefore, the driven bevel gear 44, the drive bevel gear 42, and the drive spur gear 45 can be compactly installed in the axial direction of the intermediate shaft 43. This allows the driving tool 1 to be made compact in the axial direction of the intermediate shaft 43.

As shown in FIG. 5, the driven bevel gear 44 is positioned farther from the lifter 60 than the drive spur gear 45. Therefore, the drive spur gear 45, the drive bevel gear 42, and the driven bevel gear 44 are arranged in sequence from the side closer to the lifter 60. Therefore, the shaft member (motor shaft 30a) integrally coupled with the drive bevel gear 42 can be disposed so as not to be too far from the lifter 60. This allows the driving tool 1 to be made compact.

As shown in FIGS. 5 and 14, the drive bevel gear 42 is arranged in the motor shaft 30a of the electric motor 30. The drive bevel gear 42 overlaps the stopper 90 in the left-right direction along the motor axis J1 of the electric motor shaft 30a. Therefore, the stopper 70 can be located near the upstream of the power transmission path and can be compactly arranged.

As shown in FIG. 5, the electric motor 30 is located below the driver 24. The lifter 60 is located above the driver 24. Therefore, the stopper 70 of the present disclosure can be positioned in the power transmission path that transmits the output of the motor 30 located below the driver 24 to the lifter 60 above the driver 24. This improves balance of the center of gravity of the driving tool 1, thereby enhancing its handling performance (maneuverability).

As shown in FIG. 7, the driving mechanism 20 has the piston 23 and the accumulation chamber 22. The piston 23 is movable integrally with the driver 24. The accumulation chamber 22 is pressurized by the rearward movement of the piston 23. For example, the lifter 60 receives a force in a reverse rotation direction when the driver 24 moves rearward or is held in the standby position. In the so-called gas spring type driving tool 1, the present disclosure prevents the force in the reverse rotation direction received by the lifter 60 from being transmitted upstream of the driven bevel gear 44.

Next, the second example of the present disclosure will be described with reference to FIGS. 1 to 24. The driving tool 90 of the second embodiment has a power transmission mechanism 92 instead of the power transmission mechanism 40 (refer to FIG. 5) of the driving tool 1 of the first embodiment. The power transmission mechanism 92 reduces the output of the electric motor 30 in two stages before transmitting it to the lifter 60. The power transmission mechanism 92 has a planetary reduction mechanism 93 as the upstream speed reduction section. The power transmission mechanism 92 has a bevel gear unit including a drive bevel gear 104 and a driven bevel gear 105 as the downstream speed reduction section. In the following description, only the differences from the first embodiment will be described in detail.

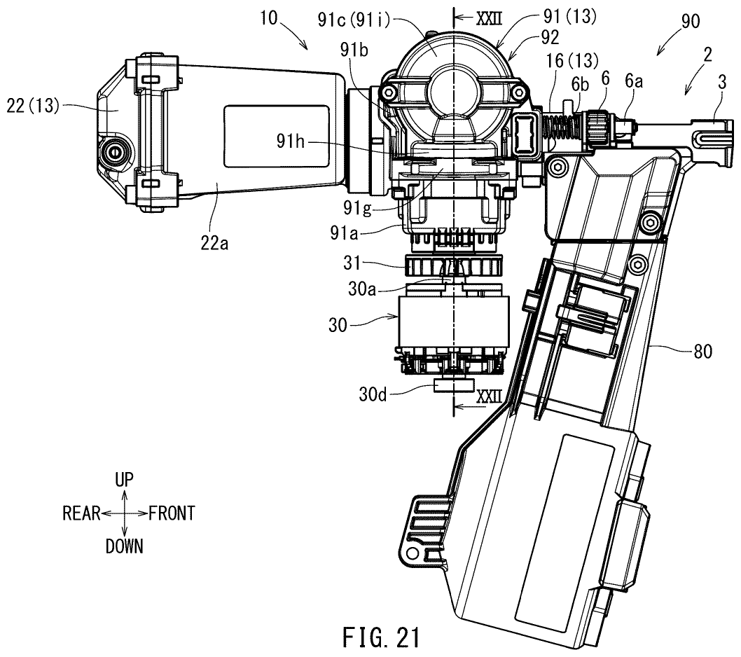

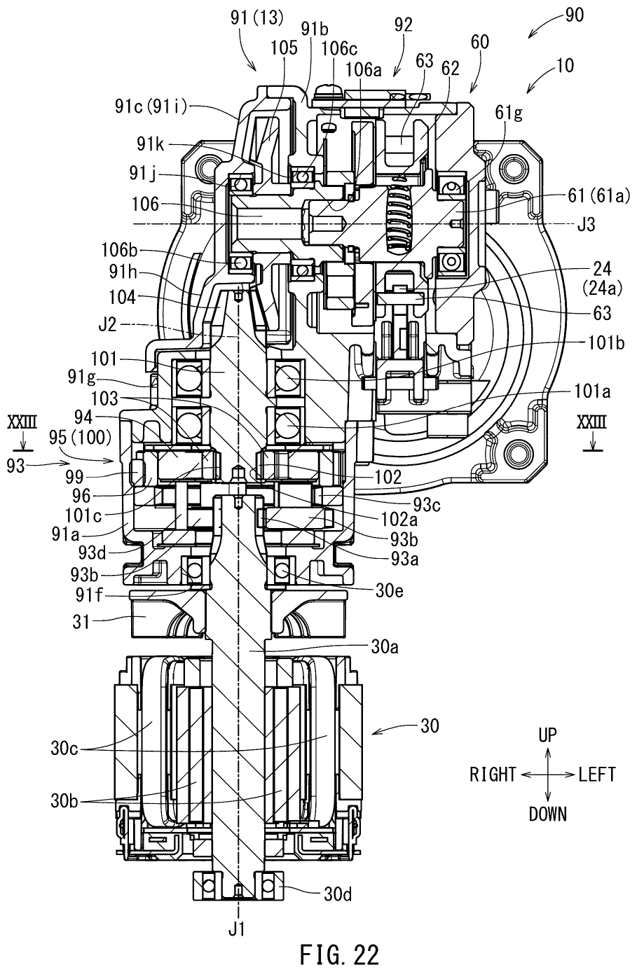

As shown in FIG. 21, the tool main body 10 has a planetary gear housing 91a, a lifter housing 91b, and a bevel gear housing 91c as mechanism housing 91 that houses the power transmission mechanism 92. As shown in FIG. 22, the planetary gear housing 91a houses the planetary gear reduction mechanism 93 that reduces the output of the electric motor 30. The bevel gear housing 91c houses the drive bevel gear 104 and the driven bevel gear 105. The bevel gear unit, which includes the drive bevel gear 104 and the driven bevel gear 105, converts the output direction of the motor from the up-down direction, where the intermediate J2 extends, to the left-right direction where the lifter axis J3 extends, while also reducing the rotational power from the planetary reduction mechanism 93. The lifter housing 91b houses the lifter 60.

As shown in FIG. 22, the planetary gear housing 91a has a cylindrical shape extending in the up-down direction. The lower end of the planetary gear housing 91a opens toward the electric motor 30, and connects to a main body housing (not shown) that covers the electric motor 30. A lifter housing 91b has a connecting portion 91g that extends rightward beyond the periphery of the lifter 60. The connecting portion 91g has s cylindrical shape, conforming to the outer profile of the planetary gear housing 91a. An upper end opening of the planetary gear housing 91a connects to the lower end of the connecting portion 91g. The bevel gear housing 91c is formed in an integrated shape combining a driving side cap 91h and a driven side cap 91i. The driving side cap 91h connects to the upper end of the connecting portion 91g of the lifter housing 91b from above and covers the driving bevel gear 104 from the right side. The driven side cap 91i connects to the lifter housing 91b covering the right end opening of the lifter housing 91b from the right side and covers the driven bevel gear 105 from the right side.

As shown in FIG. 22. the upper end of the motor shaft 30a enters the planetary gear housing 91a. A bearing 30e, which rotatably supports the upper portion of the shaft 30a, is press-fitted into a recess 91f at the lower end of the planetary gear housing 91a. A sun gear 93a of the planetary reduction mechanism 93 is positioned at the upper end of the motor shaft 30a. An internal gear 93c is arranged so as to surround the sun gear 93a from the outside. A plurality of planetary gears 93b are arranged to engage both the sun gear 93a and the internal gear 93c. A support shaft 93d extends upward from the center of each planetary gear 93b. Each support shaft 93d is inserted through a shaft insertion hole 94b in the carrier 94 disposed above via a washer 93e (refer to FIG. 4). Accordingly, the output of the electric motor 30 is reduced through the sun gear 93a and the planetary gear 93b, and transmitted to the carrier 94.

As shown in FIG. 22, an outer ring 96 is arranged on the outer circumference of the carrier 94. A stopper 95 is positioned in the transmission path of the power transmission mechanism 92, cooperating with the carrier 94 (which serves as the inner ring) and the outer ring 96 to restrict the reverse rotation of the carrier 94. A downstream rotating member 102, which is integrally formed with an intermediate shaft 101, is inserted into the center of the carrier 94. A buffering member 103 is positioned between the carrier 94 and the downstream rotating member 102. A buffering mechanism 100, which includes the carrier 94 serving as the upstream transmission member, the buffering member 103, and the downstream rotating member 102, is arranged along the transmission path of the power transmission mechanism 92.

As shown in FIG. 34, the planetary gear housing 91a has a groove 91e formed in a recessed shape, extending radially outward from a cylindrical-shaped inner circumferential surface 91d. The outer ring 96 has a plurality of projections 96b protruding radially outward from the cylindrical outer circumferential surface 96a. The outer circumferential surface of the internal gear 93c also has a plurality of projections projecting radially outward. By inserting each projection 96b of the outer ring 96 and each projection of the internal gear 93c into the groove 91e, the outer ring 96 and the internal gear 93c are prevented from rotating relative to the planetary gear housing 91a.

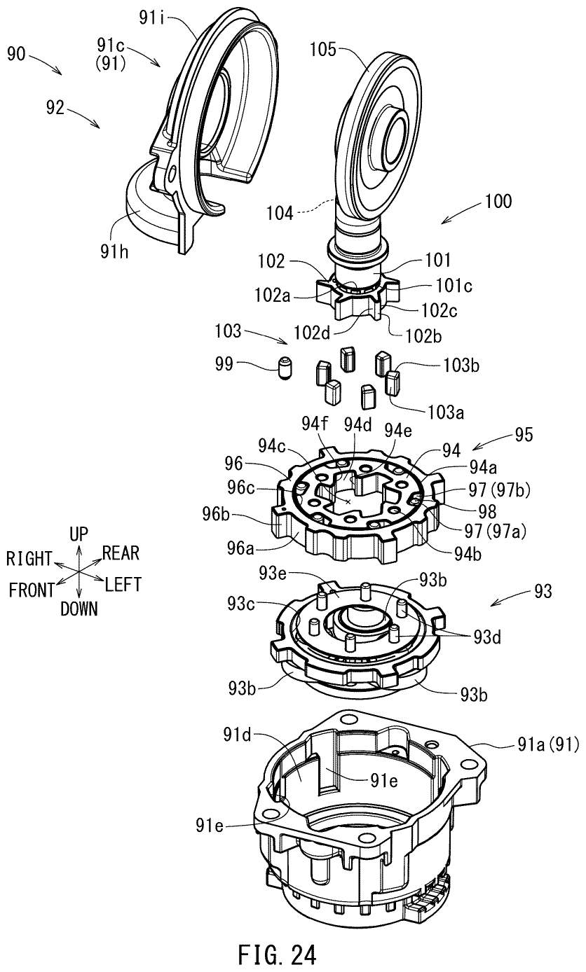

As shown in FIG. 24, a spline groove 102a extending in the up-down direction is formed on the center of the downstream rotating member 102. A spline shaft 101c is formed on the lower end of the intermediate shaft 101, which engages the spline groove 102a. As shown in FIG. 22, the intermediate shaft 101 rotates integrally with the downstream rotating member 102 around the intermediate axis J2 that extends in the up-down direction. The intermediate axis J2 is coaxial with the motor axis J1. The central portion of the intermediate shaft 101 in the up-down direction is rotatably supported by two bearings 101a and 101b. The bearings 101a and 101b are supported in the connecting portion 91g of the lifter housing 91b. By supporting the intermediate shaft 101 with two bearings 101a and 101b that are aligned in the up-down direction, shaft deflection of the intermediate shaft 101 can be suppressed.

As shown in FIG. 22, a drive bevel gear 104 is positioned at the upper end of the intermediate shaft 101. A driven bevel gear 105 is positioned on the left side of the drive bevel gear 104. The rotational power of the drive bevel gear 104 is reduced through engagement with the driven bevel gear 105, while the rotational direction is converted to align with the lifter axis J3. The driven bevel gear 105 connects to a shaft sleeve 106. The shaft sleeve 106 is rotatably supported by bearings 106b and 106c. The bearing 106b is inserted into a recess 91j in the driven side cap 91i of the bevel gear housing 91c. The bearing 106c is press-fitted into a recess 91k in the lifter housing 91b. A spline groove 106a is formed at the left end of the shaft sleeve 106 to engage in a spline connection with the shaft main body 61a of the lifter shaft 61. Accordingly, the driven bevel gear 105, the shaft sleeve 106, and the lifter shaft 61 rotate integrally on around the lifter axis J3.

### <Stopper 95>

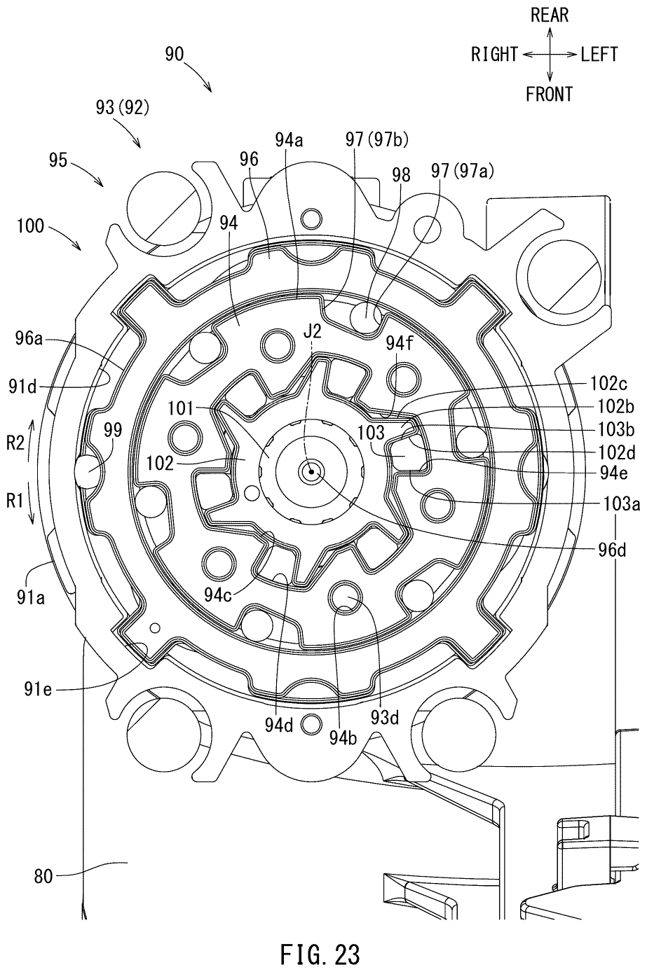

As shown in FIG. 23. a stopper 95 has an outer ring 96 and a carrier 94, both of which are formed in a cylindrical shape. An inner circumferential surface 96c of the outer ring 96 faces an outer circumferential surface 94a of the carrier 94 with a slight radial clearance. A width of the outer ring 96 is approximately the same as that of the carrier 94 (refer to FIG. 4).

As shown in FIG. 23, a plurality of wedge grooves 97 are formed on the outer circumferential surface 94a of the carrier 94. In this embodiment, six wedge grooves 97 are formed at intervals of approximately 60° in the circumferential direction. A cylindrical wedge member 98 is inserted into each of the wedge grooves 97. As shown in FIG. 24, a length of wedge member 98 in the up-down direction is approximately the same as that of the outer ring 96 and/or the carrier 94. The wedge member 98 is retained within the wedge groove 97 by an upper washer (not shown) and a lower washer 93e, preventing it from coming out of the wedge groove 97.

As shown in FIG. 23, the wedge grooves 97 are recessed radially inward from the outer circumferential surface 94a of the carrier 94 and extend circumferentially longer than the groove depth. Each of the wedge grooves 97 is formed in approximately the same shape. The groove depth of the wedge grooves 97 gradually decreases in the circumferential direction toward the forward rotation direction R1. The rear portion of the wedge groove 97 in the forward rotation direction R1 is a deep groove 97a whose depth is greater than the diameter of the wedge member 98. The front portion of the wedge groove 97 in the forward rotation direction R1 is a shallow groove 97b whose depth is smaller than the diameter of the wedge member 98.

The restriction of the forward and reverse rotation of the carrier 94 by the stopper 95 is the same as that of the stopper 70 in the first embodiment (refer to FIGS. 16 and 17). That is, when the carrier 94 rotates in the forward rotation direction R1 as shown in FIG. 23, each of the wedge members 98 moves in the wedge groove 97 toward the deep groove 97a. Therefore, a space is created between each of the wedge members 98 and the inner circumferential surface 96c of the outer ring 96 and/or between each of the wedge members 98 and the bottom of the groove of the deep groove 97a. This allows the carrier 94 to rotate in the forward rotation direction R1. When the carrier 94 begins to rotate in the reverse rotation direction R2, each of the wedge members 98 moves in the wedge groove 97 toward the shallow groove 97b. As a result, each of the wedge members 98 is sandwiched (clamped) between the inner circumferential surface 96c of the outer ring 96 and the shallow groove 97b of the wedge groove 97. For example, the rotation of the carrier 94 in the reverse rotation direction R2 is restricted when there are three or more wedge members 98 that are clamped (sandwiched) between the inner circumferential surface 96c of the outer ring 96 and the wedge groove 97.

As shown in FIG. 23, an elastic member 99 is interposed between the right portion of the outer circumferential surface 96a of the outer ring 96 and the inner circumferential surface 91d of the planetary gear housing 91a. The elastic member 99 is, for example, a cylindrical rubber member. The elastic member 99 biases the outer ring 96 toward the left. Consequently, the center 96d of the inner circumferential surface 96c of the outer ring 96 is slightly shifted to the left side of the intermediate shaft axis J2, which is the rotational center of the carrier 94. As a result, the radial distance from the bottom of each wedge groove 97 to the inner circumferential surface 96c of the outer ring 96 varies depending on the groove's position. Specifically, the radial distance is slightly shorter in the wedge groove 97 located to the right of the intermediate axis J2, and slightly longer in the wedge groove 97 located to the left of J2. By varying the radial direction from the bottom of each wedge groove 97 to the inner circumferential surface 96c of the outer ring 96, the rotation of the carrier 94 in the reverse rotation direction R2 can be more reliably restricted, similar to the function in the first embodiment. Furthermore, by positioning the stopper 95 on the outer circumference of the buffering member 103, the angle of rotation of the carrier 94 is reduced when the stopper 9 restricts reverse rotation. Therefore, the reverse rotation of the planetary reduction mechanism 93 can be more reliably restricted.

### <Buffering Mechanism 100>

As shown in FIG. 23, the buffering mechanism 100 has the carrier 94 serving as an upstream rotating member, the downstream rotating member 102, and the buffering member 103. The hole 94c penetrating in the up-down direction is formed in the radial center of the carrier 94. The downstream rotating member 102 and the buffering member 103 are inserted into the hole 94c. As shown in FIG. 24, a width of the buffering member 103 in the up-down direction is approximately the same as that of the carrier 94 and/or the downstream rotating member 102. However, the width of the buffering member 103 is made slightly shorter than that of the carrier 94 and/or the downstream rotating member 102, taking into account the clearance required for elastic deformation.

As shown in FIG. 23, the hole 94c of the carrier 94 is gear-shaped with repeated concave and convex contours along the circumferential direction. In this embodiment, six recesses 94d are formed at approximately 60° intervals in the circumferential direction. The recesses 94d have upstream side surfaces 94e on the upstream side in the forward rotation direction R1 and downstream inclined side surfaces 94f on the downstream side in the forward rotation direction R1. Both the upstream side surface 94e and the downstream side surface 94f extend straight in the up-down direction, without axial inclination. The upstream side surface 94e extends approximately straight in a radial direction toward the intermediate axis J2. The downstream inclined side surface 94f extends outwardly in the radial direction and is inclined toward the reverse rotation direction R2 (clockwise direction in FIG. 23). The outer radial ends of the upstream side surface 94e and the downstream inclined side surface 94f are connected by a circular arc-shaped bottom surface centered on the intermediate axis J2.

As shown in FIG. 23, the downstream rotating member 102 is gear-shaped with a plurality of projections 102b protruding radially outward from its outer circumferential surface. In this embodiment, six projections 102b are formed at approximately 60° intervals in the circumferential direction. Each projection 102b is inserted into the recess 94d in the carrier 94. Each projection 102b has a downstream side surface 102d that is located downstream of the upstream side surface 94e of the carrier 94 in the forward rotation direction R1. Also, each projection 102b has an upstream side surface 102c located upstream of the downstream side surface 94f of the carrier 94 in the forward rotation direction R1.

As shown in FIG. 23, the downstream side surface 102d and the upstream side surface 102c extend straight in the up-down direction, without inclination. The downstream side surface 102d extends approximately straight in a radial direction toward the intermediate axis J2. The upstream side surface 102c extends outward in the radial direction, and is inclined toward the reverse rotation direction R2 (clockwise direction in FIG. 23). The inclined angle of the upstream side surface 102c in the radial direction is smaller than that of the downstream side surface 94f of the carrier 94. The upstream side surface 102c faces the downstream side surface 94f of the carrier 94 in the circumferential direction.

As shown in FIG. 2 1, six buffering members 103 are positioned in the buffering mechanism 100. The buffering members 103 are made of, for example, highly elastic rubber. The buffering members 103 are formed in substantially the same shape. Each of the buffering members 103 has a fan shape when viewed from above or below. The outer circumferential surface of each buffering member 103 faces the bottom surface of the recess 94d of the carrier 94 in a radial direction. The inner circumferential surface of the buffering member 103 faces the outer circumferential surface of the downstream rotating member 102 in the radial direction.

As shown in FIG. 23, the buffering member 103 has a second side surface 103b located on the front side in the forward rotation direction R1 and a first side surface 103a located on the rear side in the forward rotation direction R1. The first side surface 103a and the second side surface 103b both extend in a flat plane in the up-down direction. Each buffering member 103 is housed in the recess 94d of the carrier 94 and is positioned on the rear side of the projection 102b of the downstream rotating member 102 in the forward rotation direction R1. The first side surface 103a of the buffering member 103 faces and elastically contacts the upstream side surface 94e of the carrier 94 in the circumferential direction. The second side surface 103b of the buffering member 103 faces and elastically contacts the downstream side surface 102d of the downstream rotating member 102 in the circumferential direction.

As shown in FIG. 23, the carrier 94 rotates in the forward rotation direction R1 around the intermediate axis J2 by transmission of the output from the electric motor 30 (refer to FIG. 22). At this time, the upstream side surface 94e of the carrier 94 first elastically pushes the first side surface 103a of the buffering member 103 in the forward rotation direction R1. Furthermore, the second side surface 103b of the buffering member 103 elastically presses the downstream side surface 102d of the downstream rotating member 102 in the forward rotation direction R1. As a result, the downstream rotating member 102 and the intermediate shaft 101 integrally rotate in the forward rotation direction R1 around the intermediate axis J2.

As shown in FIG. 23, there is a case in which the downstream rotating member 102 is urged to rotate in the reverse rotation direction R2 together with the intermediate shaft 101. At this time, the downstream side surface 102d of the downstream rotating member 102 first elastically pushes the second side surface 103b of the buffering member 103 in the reverse rotation direction R2. Furthermore, the first side surface 103a of the buffering member 103 elastically pushes the upstream side surface 94e of the carrier 94 in the reverse rotation direction R2. As a result, the impact from the downstream rotating member 102 is reduced by the buffering member 103, thereby suppressing the transmission of the impact to the carrier 94 and its upstream side.

According to the driving tool 90 of the second embodiment achieves the same effect as that of the first embodiment. Furthermore, as shown in FIGS. 4 and 23, the driving tool 90 positions the planetary reduction mechanism 93, the bevel gear unit 104, 105, and the buffering members 103 in the power transmission path of the power transmission mechanism 92. The planetary reduction mechanism 93 reduces the output of the electric motor 30. The bevel gear unit 104, 105 changes the direction of the output of the electric motor 30. Accordingly, the carrier (upstream rotating member) 94 is positioned between the electric motor 30 and the buffering members 103. When the upstream rotating member (carrier) 94 receives the output of the electric motor 30 and rotates in the forward rotation direction R1, the buffering member 103 transmits the rotational power of the carrier 94 to the downstream rotating member 102 while absorbing the impact. Therefore, the output of electric motor 30 can be reliably transmitted to the lifter 60. Additionally, when an impact is transmitted from the lifter 60 to the downstream rotating member 102, the impact is absorbed by the buffering members 103 before it is transmitted to the carrier 94, because the buffering members 103 are always interposed between the downstream rotating member 102 and the carrier 94. This prevents the impact from the lifter 60 from being transmitted to the electric motor 30 and the power transmission path located upstream of the buffering members 103.

As shown in FIGS. 22 and 24, the bevel gear unit 104,105 is positioned downstream of the planetary reduction mechanism 93. The carrier 94, the downstream rotating member 102, and the buffering members 103 are positioned on the downstream side of the planetary reduction mechanism 93 and on the upstream side of the bevel gear unit 104, 105. Therefore, the carrier 94, the downstream rotating member 102, and the buffering member 103 can be located downstream of the planetary reduction mechanism 93. Therefore, the carrier 94, the downstream rotating member 102, and the buffering members 103 can be assembled together with the assembly of the planetary reduction mechanism 93. This improves the workability of the assembly work. Also, by arranging the carrier 94, the downstream rotating member 102, and the buffering members 103 upstream of the bevel gear unit 104, 105, the design flexibility is improved. For example, the bevel gear unit 104, 105 and the lifter 60 can be positioned closer together along the lifter axis J3.

As shown in FIG. 23, the stopper 95 for restricting the reverse rotation is arranged in the power transmission path. The carrier 94, which serves as a holding member for the buffering members 103, also serves as a structural component of the stopper 95. Therefore, the buffering mechanism including the buffering members 103 and the stopper 95 can be compactly arranged.

Various changes can be made to the driving tool 1 of the present embodiment described above. A gas spring-type driving tool is illustrated as an example of the driving tool 1. Instead, the present disclosure may be applied to a mechanical spring-type driving tool. A staple is illustrated as an example of the driving members N. Instead, the present disclosure may be applied to a driving tool in which nails are driven as the driving members N.

In the embodiment, the motor housing 12 is disposed on the right side of the magazine 80. Instead, the motor housing 12 may be disposed on the left side of the magazine 80. In the embodiment, the magazine 80 extends straight downward from the driving nose 2. Instead, the magazine 80 may be inclined in the left-right direction toward the bottom.

In the embodiment, the motor housing 12 is clamped between the left and right half-split lower housing 11d and connected thereto. Instead, the lower housing 11d and the motor housing 12 may be directly screwed together. In the embodiment, the exhaust hole 12a penetrates the motor housing 12. Instead, the exhaust hole 12a may be provided in the fastened portion 14b of the gear housing 14.

In the embodiment, the controller 35 is housed in the lower housing 11d below the motor housing 12 with its longitudinal direction in the up-down direction. However, an orientation of the controller 35 are not limited to the illustrated embodiment, and may be changed as appropriate. For example, the longitudinal direction of the controller 35 may be inclined in the front-rear direction or in the up-down direction.

In the embodiment, the rubber ring 18 is placed between the inner surface of the upper housing 11a and the outer surface of the mechanism housing. However, the position and number of rubber rings 18 may be changed as appropriate and are not limited to the illustrated positions. In addition, a spring may be placed instead of the rubber rings 18.

In the embodiment, the speed reduction mechanism 41 that reduces speed in two stages, i.e. the upstream speed reduction section 41a and the downstream speed reduction section 41b. The upstream speed reduction section 41a includes the bevel gears engaging with each other, and the downstream speed reduction section 41b includes the spur gears engaging with each other. However, the number of reduction stages, the types of gears, the order, etc. are not limited to the illustrated embodiment and may be changed as appropriate. For example, only one reduction stage or three or more reduction stages may be used. Instead of the engagement between the spur gears, an engagement between helical gears may be used in the reduction portion. For example, the upstream speed reduction portion may be an engagement between spur gears or helical gears, and the downstream speed reduction portion may be an engagement between bevel gears. Furthermore, in case of the three-stage reduction, the first stage may be a bevel gear engagement, and the second and third stages may be a spur gear engagement or a helical gear engagement. Alternatively, the first and third stages may be a spur gear engagement or a helical gear engagement, and the second stage may be a bevel gear engagement.

In the embodiment, the stopper 70 is positioned on the outer circumference of the intermediate shaft 43. Specifically, the stopper 70 is located on the downstream side of the driven bevel gear 44 and on the upstream side of the driving spur gear 45. However, the position of the stopper 70 is not limited to this location. The stopper 70 may be positioned on the outer circumference of the lifter shaft 61. Alternatively, a drive spur gear or a drive helical gear may be arranged on the downstream end of the motor shaft 30a, and the stopper 70 may be positioned on the outer circumference of the motor shaft 30a. Furthermore, if the speed reduction mechanism utilizes three or more stages, the stopper 70 may be positioned on the outer circumference of any of the rotating members on the downstream side of the driven bevel gear.

In the embodiment, the stopper 70 has six wedge grooves 73 and six wedge members 74. However, the number of wedge grooves 73 and wedge members 74 is not limited and may be changed as appropriate. In the embodiment, the wedge groove 73 are formed on the outer circumferential surface 72a of the inner ring 72. Instead, the wedge groove 73 may be formed radially outward on the inner circumferential surface 71c of the outer ring 71 in a recessed manner.

In the embodiment, the buffering mechanism 50 is provided in the outer circumference of the lifter shaft 61 and includes the follower spur gear 51. However, the position and configuration of the buffering mechanism 50 are not limited and may be changed as appropriate. For example, the upstream rotating member may not serve as a reduction gear, and the buffering mechanism 50 may be arranged on the downstream side of the follower spur gear 51. Furthermore, the buffering mechanism 50 may be arranged upstream of the downstream speed reduction gear, for example, in the outer circumference of the intermediate shaft 43.

In the embodiment, the lifter shaft 61 and the driving ring 52 are rotatably connected as a unit via the balls 54. Alternatively, the lifter shaft 61 and the driving ring 52 may be rotatably connected as a unit, for example, by means of a spline shaft engagement. In the engagement, the hemispherical ball hole 61d is arranged in the lifter shaft 61 and the ball groove 52f extending in the axial direction is arranged in the driving ring 52. Alternatively, ball grooves extending in the axial direction may be arranged in both the lifter shaft 61 and the driving ring 52, and the balls 54 may be positioned in the axial direction at the bottom of the ball grooves. In the embodiment, the buffering mechanism 50 has three buffering members 53. However, the number of buffering members 53 is not limited and may be changed as appropriate.

In the embodiment, the driving tool 90 has a two-stage speed reduction mechanism unit including the planetary reduction mechanism 93 and the bevel gear unit 104, 105. Alternatively, for example, the driving tool 90 has a two-stage reduction mechanism unit including the planetary reduction mechanism 93 and a spur gear unit, or a three-stage reduction mechanism unit including the planetary reduction mechanism 93, a bevel gear unit, and a spur gear unit. The order of the respective reduction units may be changed as appropriate.

We claim:

1. A driving tool comprising:
a driving mechanism configured to bias a driver forward;
a lifter configured to move the driver rearward;
an upstream rotating member positioned in a power transmission path that transfers power from an electric motor to the lifter, the upstream rotating member being configured to rotate around an axis thereof;
a downstream rotating member configured to rotate coaxially with the upstream rotating member on a downstream side of the upstream rotating member; and
a buffering member interposed between the upstream rotating member and the downstream rotating member, wherein
a rotational power of the upstream rotating member is transmitted to the downstream rotating member while being buffered through the buffering member.

2. The driving tool according to claim 1, wherein the buffering member includes a first side surface and a second side surface,
the first side surface is substantially perpendicular to and elastically contacts an upstream side surface of the upstream rotating member in a rotation direction, and
the second side surface is substantially perpendicular to and elastically contacts a downstream side surface of the downstream rotating member in the rotation direction relative to the first side surface.

3. The driving tool according to claim 2, wherein
the upstream rotating member includes an upstream inclined side surface that is inclined relative to the rotation direction,
the downstream rotating member includes a downstream inclined side surface that faces the upstream inclined side surface and is inclined in the rotation direction.

4. The driving tool according to claim 1, wherein
the downstream rotating member rotates integrally with a lifter shaft of the lifter, and
the upstream rotating member rotates integrally with a final driven gear at a most downstream position in the power transmission path.

5. The driving tool according to claim 4, further comprising a ball that is interposed between an inner circumferential surface of the downstream rotating member and an outer circumferential surface of the lifter shaft, wherein
the downstream rotating member and the lifter shaft are configured to be coupled together through the ball to prevent relative rotation therebetween.

6. The driving tool according to claim 1, wherein
the upstream rotating member further includes external teeth formed on the outer circumferential surface thereof and a recess formed on a surface thereof facing the downstream rotating member, and
at least a part of the buffering member is housed within the recess.

7. The driving tool according to claim 6, wherein the buffering member is housed within an axial width of the upstream rotating member.

8. The driving tool according to claim 7, wherein
the upstream rotating member further includes an upstream disc portion that covers the buffering member in an axial direction of the upstream rotating member, and
the downstream rotating member further includes a downstream disc portion that covers the buffering member from an opposite side of the upstream disc portion.

9. The driving tool according to claim 8, wherein
the buffering member includes a protrusion projecting in the axial direction, and
the protrusion is configured to elastically contact the upstream disc portion or the downstream disc portion.

10. The driving tool according to claim 1, wherein
the power transmission path includes a planetary reduction mechanism, a bevel gear unit, and the buffering member,
the planetary reduction mechanism is configured to reduce an output of the electric motor, and
the bevel gear unit is configured to change a direction of the output of the electric motor.

11. The driving tool according to claim 10, wherein
the bevel gear unit is positioned downstream of the planetary reduction mechanism, and
the upstream rotating member, the downstream rotating member, and the buffering member are positioned on a downstream side of the planetary reduction mechanism and on an upstream side of the bevel gear unit.

12. The driving tool according to claim 10, further comprising a stopper configured to restrict a reverse rotation of the planetary reduction mechanism, and a holding member for the buffering member, wherein
the holding member is configured to serves as a structural component of the stopper.

13. The driving tool according to claim 1, wherein the driving mechanism includes a piston configured to move integrally with the driver and an accumulation chamber configured to be pressurized by a rearward movement of the piston.

14. The driving tool according to claim 1, wherein the buffering member is substantially fan-shaped when viewed from a direction in which the buffering member is inserted between the upstream rotating member and the downstream rotating member.

15. The driving tool according to claim 3, wherein the upstream inclined side surface and the downstream inclined side surface are inclined at substantially the same angle.

16. The driving tool according to claim 3, wherein
the upstream rotating member includes an upstream protrusion, the upstream protrusion having the upstream side surface and the upstream inclined side surface, and
the downstream rotating member includes a downstream protrusion, the downstream protrusion having the downstream side surface and the downstream inclined side surface.

17. The driving tool according to claim 16, wherein the buffering member is circumferentially interposed such that the first side surface elastically contacts the upstream side surface of the upstream protrusion and the second side surface elastically contacts the downstream side surface of the downstream protrusion.

18. The driving tool according to claim 10, wherein the upstream rotating member is a carrier of the planetary reduction mechanism.

19. The driving tool according to claim 12, wherein the holding member includes a carrier of the planetary reduction mechanism.

20. The driving tool according to claim 18, wherein
the carrier includes a hole at a radial center thereof, the hole having a recess formed in a circumferential direction of the carrier,
the downstream rotating member includes a projection extending radially outward from an outer circumferential surface thereof, and
the buffering member is interposed between the recess and the projection.
